(19) United States
(12) Patent Application Publication
(10) Pub. No.: US 2005/0169159 A1
(43) Pub. Date: Aug. 4, 2005

(54) Optical disk, recording and reproducing apparatus for the same, and method for managing address information

(75) Inventors: Reiji Tamura, Moriya-shi (JP); Hiroshi Shirai, Moriya-shi (JP); Tamotsu Iida, Tsuchiura-shi (JP); Makoto Miyamoto, Moriya-shi (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 11/028,586

(22) Filed: Jan. 5, 2005

(30) Foreign Application Priority Data
Jan. 6, 2004 (JP) 2004-001119
Mar. 10, 2004 (JP) 2004-067300
Mar. 18, 2004 (JP) 2004-078219

(51) Int. Cl. G11B 7/24

(52) U.S. Cl. 369/275.3; 369/275.2; 369/275.4

(57) ABSTRACT

An optical disk includes a substrate which is formed with a plurality of grooves, and a recording layer which is provided on the substrate and which is formed of a phase-change material containing Bi, Ge, and Te. Each of the grooves is provided with a header section on which address information of the groove is recorded. The header section is formed by deflecting the grooves in the radial direction. The header sections of the respective grooves are arranged and aligned in the radial direction. Even when the address information of the predetermined groove was failed to be reproduced, the address information of the predetermined groove is specified from the address information of the adjoining groove. Accordingly, an optical disk is provided, which has a larger capacity, which has high reliability, and which is excellent in durability with respect to repeated writing of data information.

### BACKGROUND OF THE INVENTION

1. Field of the Invention

The present invention relates to an optical disk on which information is recorded by radiating an energy beam, a recording and reproducing apparatus for the same, and a method for managing address information. In particular, the present invention relates to an optical disk on which address information is recorded by deflecting the groove in the radial direction, a recording and reproducing apparatus for the same, and a method for managing address information.

2. Description of the Related Art

In recent years, the market is expanded in relation to the read-only type optical disk such as DVD-ROM and DVD-Video. In succession thereto, the market is also expanded in relation to the rewritable DVD such as DVD-RAM, DVD-RW, and DVD+RW. The rewritable DVD as described above has quickly come into widespread use as the backup medium for computers and the picture-recording medium in place of VTR. As the DVD market is expanded as described above, the demand is further increased from day to day for the high definition image and the long time recording, and the demand is increased from day to day for the reliability of the data when the medium is repeatedly used. Therefore, the important technical task is to realize the high density of the optical disk and improve the durability with respect to the repeated data recording.

A variety of techniques have been hitherto suggested in order to realize the high density information recording on the optical disk. Those having been suggested include, for example, a method in which the recording mark is made fine and minute by using the blue laser having a shorter wavelength (λ=405 nm), and a method in which the track density is allowed to have a high density by performing the recording on both of the land and the groove. Further, in view of the format, various optical disks have been also suggested, which contrive not only the data-recording section but also the structure of the header section for storing, for example, the address information. For example, in the case of iD-photo, the guide groove is deflected in the radial direction of the track to record information of the header section on only one side of the recording track, and thus the format efficiency is enhanced so that the system is successfully constructed without providing any long cutting of the recording track.

In relation to the technique of the optical disk on which information is rewritable, the phase-change recording system is generally acknowledged, which is adopted, for example, for DVD-RAM and DVD-RW. In the case of the optical disk based on the phase-change recording system, a phase-change material is used for a recording layer. Basically, the pieces of information of “0” and “1” are allowed to correspond to the crystalline state (non-recorded state) and the amorphous state (recorded state) of the phase-change material respectively to perform the recording. The refractive index differs between the areas in the crystalline state and the amorphous state formed in the recording layer. Therefore, for example, the refractive indexes and the thicknesses of the respective layers for constructing the optical disk are designed so that the difference in the refractive index is maximized between the portion which is changed to be in the crystalline state and the portion which is changed to be in the amorphous state. In the case of the optical disk based on the phase-change recording system, the light beam is radiated on the crystalline portion and the amorphous portion to detect the difference in the amount of light reflected from the respective portions of the optical disk so that “0” of and “1”, which are recorded in the recording layer, are detected.

In order that the predetermined position of the recording layer is made amorphous on the optical disk based on the phase-change recording system (usually, this operation is called “recording”), a light beam, which has a relatively high power, is radiated to effect the heating so that the temperature of the irradiated portion of the recording layer is not less than the melting point of the recording layer material. On the other hand, in order that the predetermined position of the recording layer is made crystalline (usually, this operation is called “erasing”), a light beam, which has a relatively low power, is radiated to effect the heating so that the temperature of the irradiated portion of the recording layer is not more than the melting point of the recording layer material and the temperature is in the vicinity of the crystallization temperature. As described above, in the case of the optical disk based on the phase-change recording system, the predetermined portion in the recording layer can be reversibly changed between the amorphous state and the crystalline state by regulating the radiation power of the light beam to be radiated onto the recording layer.

According to the principle of the phase-change recording system as described above, the phase-change recording material to be used for the recording layer is preferably such a material that the difference in the refractive index is large between the amorphous state and the crystalline state, and the amorphous portion is crystallized in an extremely short period of time during the erasing operation. Further, it is preferable to use such a material that the deterioration is scarcely caused when the recording and the erasing are repeatedly performed. Taking the viewpoints as described above into consideration, various phase-change materials have been hitherto investigated. For example, Japanese Patent No. 1780615 discloses a technique which relates to a Ge—Sb—Te-based recording material. Japanese Patent Application Laid-open No. 2001-322357 discloses an information-recording medium in which the high density recording can be performed, the repeated rewriting performance is excellent, and the crystallization sensitivity is scarcely deteriorated in a time-dependent manner, as obtained by using, as a recording material, a material in which a metal such as Ag, Al, Cr, and Mn is added to a Ge—Sn—Sb—Te-based material. Japanese Patent Application Laid-open No. 2-147289 also discloses a Ge—Sb—Sn—Te-based recording layer material. Other exemplary conventional techniques are also known. Japanese Patent Application Laid-open Nos. 62-73439 and 1-220236 disclose Bi—Ge—Se—Te-based phase-change recording materials. Japanese Patent Application Laid-open No. 1-287836 discloses a practical range of a Bi—Ge—Sb—Te-based phase-change recording material.

Conventionally, Japanese Patent Application Laid-open No. 62-209741 discloses an example in which a Bi—Ge—Te-based phase-change recording material is used as a phase-change recording material, and a practical composition range thereof is prescribed. Further, a Bi—Ge—Te-based phase-change recording material is also suggested in order to improve the repeating characteristic (see, for example, Japanese Patent Nos. 2574325 (pp. 3-5) and 2592800 (pp. 2-4).

In order to develop an optical disk which has a large capacity, which has high reliability, and which has high durability with respect to the repeated recording of data information, the inventors have manufactured an optical disk having a narrow track pitch such that the conventional phase-change recording material as described above is used as a material for forming a recording layer, and the header information (address information) of the optical disk is recorded by deflecting (wobbling) the guide groove in the radial direction. That is, the optical disk has been manufactured by combining the conventional techniques as described above. However, various optical disks were manufactured under various design conditions. The recording and reproduction characteristics were evaluated for the optical disks as described above. As a result, the following fact has been revealed. That is, it is difficult to realize an optical disk which has a large capacity, which has high reliability, and which has high durability with respect to the repeated recording of data information. An explanation will be made below about problems which have arisen in the evaluation.

In order to realize an optical disk having a high recording density, it is necessary to narrow the track pitch. However, it the track pitch is too narrowed, a problem has arisen such that it is impossible to provide any sufficient deflection amount (wobble amount) of the guide groove to record the address information. Specifically, if the deflection amount of the groove is increased when the track pitch is narrow, a problem has arisen such that the signal, which is brought about by the deflection of the groove, tends to cause leakage and mixing as the noise component of the data signal (reproduced signal), and the quality of the data signal is deteriorated as compared with a case in which the track pitch is wide. On the contrary, if the wobble amount is set to such an extent that the data signal quality can be sufficiently secured, the wobble amount is decreased. Therefore, the quality of the header signal including the address information is deteriorated, and it is difficult to reliably reproduce the address information.

Further, an optical disk has been manufactured by using the conventional phase-change recording material as described above to repeatedly rewrite the data information. As a result, a problem has arisen such that the reliability of the header signal is greatly lowered due to the deterioration of the data signal quality caused by the rewriting. This phenomenon is considered to be caused by the following reason. As described above, it is necessary to narrow the track pitch and decrease the wobble amount as well. As a result, the quality of the header signal is not only deteriorated, but the margin of S/N (signal-to-noise ratio) of the header signal is also decreased. Therefore, even if the deterioration of the data signal, which is caused by the rewriting performed many times, is at a minute level of such an extent that no problem arises in the case of the conventional optical disk, then the deterioration of the data signal greatly affects the quality of the header signal, and the reliability of the header signal is greatly lowered.

Further, when the recording layer is formed of the conventional phase-change recording material, the surroundings of the recording marks in the amorphous state of the recording layer are recrystallized after melting the phase-change material to form the recording mark. Therefore, an area (referred to as “recrystallization area” as well), which is composed of relatively large crystal grains, is formed around the recording marks. When the rewriting is repeated, a “band” of the recrystallization area is formed at a position just outside the width of the recording mark. In the area in which the “band” is formed, the crystal grain size is large, and the size is dispersed. Therefore, the reflectance of the recording layer is varied depending on the dispersion of the grain diameter size in the recrystallization area, and the variation of the reflectance harmfully affects the header signal.

When the track pitch is wide, if the data signal is deteriorated by the rewriting performed many times, or if the “band” of the recrystallization is formed, then the influence, which is exerted on the header signal quality thereby, is small. However, if the track pitch is narrowed, the influence conspicuously appears on the characteristics. The problem of the deterioration of the header signal, which is caused when the rewriting is performed many times, appears especially conspicuously when the blue laser beam (λ=405 nm) is used as the recording laser beam. This is considered to be caused for the following reason. That is, the beam diameter is focused in the case of the blue laser beam as compared with the red laser beam (λ=650 nm) used for DVD. Therefore, the energy density is high at the beam center, and the damage is increased by the repeated rewriting.

### SUMMARY OF THE INVENTION

The present invention has been made in order to solve the problems as described above, an object of which is to provide an optical disk which has a larger capacity, which has high reliability, and which is excellent in durability with respect to the repeated recording of data information.

According to a first aspect of the present invention, there is provided an optical disk comprising:
a substrate which is formed with a plurality of grooves; and
a recording layer which is provided on the substrate and which is formed of a phase-change material containing Bi, Ge, and Te, wherein:
header sections are provided for the plurality of grooves respectively, address information of each of the groove is recorded on one of the header sections of the grooves by deflecting the grooves in a radial direction, and the header sections of the plurality of grooves are arranged and aligned in the radial direction.

According to a second aspect of the present invention, there is provided an optical disk comprising:
a substrate which is formed with a plurality of grooves; and
a recording layer which is provided on the substrate and which is formed of a phase-change material containing Bi of not more than 28 atomic %, wherein:
header sections are provided for the plurality of grooves respectively, address information of each of the grooves is recorded on one of the header sections of the grooves by deflecting the grooves in a radial direction, and the header sections of the plurality of grooves are arranged and aligned in the radial direction.

FIG. 2 shows an example of the optical disk according to the first and second aspects of the present invention. As shown in FIG. 2, in the case of the optical disk of the present invention, the address information of the header section (address area in FIG. 2) is recorded by deflecting the groove in the radial direction. The address areas of the respective grooves are arranged in an aligned manner in the radial direction of the optical disk. In the case of the optical disk shown in FIG. 2, one track is constructed by one set of the groove and the land which are adjacent to one another, and the groove and the land are designated by the same track number. That is, in the case of the optical disk shown in FIG. 2, the address information, which is formed in the groove, is the address information of the track including the groove.

In the case of the optical disk according to the first and second aspects of the present invention, when the address information of the predetermined track was failed to be reproduced, then the light beam is moved to the adjoining track to reproduce the address information of the adjoining groove, and the address information of the predetermined track is specified from the address information of the adjoining track. Therefore, the reliability of the address information is enhanced. Even when the track pitch is decreased in order to obtain a large capacity, the reliability of the address information is not lowered.

As shown in FIG. 2, in the case of the optical disk according to the first and second aspects of the present invention, the address information of the track adjoining the predetermined track is arranged at the same position in the radial direction as that of the address information of the predetermined track. Therefore, the address information of the adjoining groove can be obtained with ease by only moving the light beam to the adjoining track. Therefore, it is possible to quickly reproduce the address information of the predetermined track on the basis of the address information of the adjoining track.

In the optical disk according to the first aspect of the present invention, the recording layer is formed of the phase-change material containing Bi, Ge, and Te. When the recording layer is formed of the phase-change material containing Bi, Ge, and Ti, the sufficient quality of the data signal is obtained even when the deflection amount of the wobble of the header section for forming the address information is increased to some extent as described later on. Further, even when the data information is repeatedly rewritten, it is possible to suppress the deterioration of the signal quality. Therefore, in the optical disk according to the first aspect of the present invention, the reliability of the address information is not only improved, but the repeated rewriting characteristic of the data information can be also improved.

In the optical disk according to the second aspect of the present invention, the recording layer is formed of the phase-change material containing Bi and containing the compound based on at least one of the crystalline systems of the cubic system and the tetragonal system. When the recording layer is formed of the phase-change material as described above, the sufficient quality of the data signal is obtained even when the deflection amount of the wobble of the header section for forming the address information is increased to some extent as described later on. Further, even when the data information is repeatedly rewritten, it is possible to suppress the deterioration of the signal quality. Therefore, in the optical disk according to the second aspect of the present invention, the reliability of the address information is not only improved, but the repeated rewriting characteristic of the data information can be also improved. The phase-change material for the recording layer may contain Te. In particular, the phase-change material for the recording layer may contain Ge and Te. Further, the phase-change material for the recording layer may have at least one of crystalline systems of a cubic system and a tetragonal system.

In the case of the optical disk according to the first and second aspects of the present invention, a plurality of lands may be defined between the plurality of grooves, header sections may be provided for the plurality of lands respectively, address information of each of the lands may be recorded on one of the header sections of the lands by deflecting the lands in a radial direction, and the header sections of the plurality of lands may be arranged and aligned in the radial direction.

In the case of the optical disk as described above, the information, which relates to the address information of the groove and the land adjoining the groove and the land, may be recorded on the respective header sections provided for the groove and the land. The address information may include information in relation to a recording position of the address information.

FIG. 7 (FIGS. 7A and 7B) shows an example of the optical disk as described above. In the case of the optical disk shown in FIG. 7, the data (recording mark) is recorded on the groove and the land (not shown). As shown in FIG. 7, the address information of each of the grooves and the lands is formed by wobbling the groove and the land in the radial direction respectively. As shown in FIG. 7, the header section of each of the grooves and the lands is composed of first to fourth address areas. The header sections of the respective grooves and the lands are arranged in an aligned manner in the radial direction of the optical disk. In the case of the optical disk shown in FIG. 7, one track is formed by one set of the groove and the land which are adjacent to one another, and the groove and the land are designated by the same track number.

In the optical disk shown in FIG. 7, the address information of the groove and the land adjoining the predetermined groove and the land is recorded on the header section of the predetermined groove and the land. The address information thereof is recorded in the area which is different from the address area in which the address information of the predetermined groove and the land is recorded. For example, the address information G(2k) of the 2kth groove is recorded in the first address area of the 2kth groove shown in FIG. 7. Further, the address information L(2k) of the 2kth land, the address information G(2k+1) of the (2k+1)th groove, and the address information L(2k−1) of the (2k−1)th land are recorded in the second, third, and fourth address areas respectively. On the 2kth land shown in FIG. 7, the address information L(2k) of the 2kth land is recorded in the second address area, and the address information G(2k+1) of the (2k+1)th groove is recorded in the third address area. In the case of the example of the optical disk shown in FIG. 7, for example, the first address area on the 2kth land shown in FIG. 7 is the boundary portion between the address information G(2k) of the 2kth groove and the address information G(2k+2) of the (2k+2)th groove as shown in FIG. 7. Therefore, the address information is absent. Similarly, the fourth address area on the 2kth land shown in FIG. 7 is also the boundary portion between the address information L(2k−1) of the (2k−1)th land and the address information L(2k+1) of the (2k+1)th land. Therefore, the address information is absent.

In the case of the optical disk as shown in FIG. 7, for example, when the 2kth groove is scanned across the light beam in the broken line arrow shown in FIG. 7 to reproduce the address information, the address information is detected in an order of the address information G(2k) of the 2kth groove, the address information L(2k) of the 2kth land, the address information G(2k+1) of the (2k+1)th groove, and the address information L(2k−1) of the (2k−1)th land. Therefore, when the 2kth groove is scanned across the light beam in the direction of the broken line arrow shown in FIG. 7, even if the address information G(2k) of the 2kth groove (information in the first address area) cannot be reproduced, the address information G(2k) of the 2kth groove can be specified from the address information of the land and the groove adjoining the 2kth groove recorded in other address areas and the information about the detection sequence thereof or the like. Further, when the position information of the address area in which the address information is recorded is recorded in each of the address information, it is easier to specify the address information of the predetermined groove and the land.

As described above, in the case of the optical disk as shown in FIG. 7, even if the address information of the predetermined groove or the land cannot be reproduced, the address information of the predetermined groove or the land can be reproduced more easily and highly reliably without moving the light beam to the adjoining land or the groove. Therefore, in the case of the optical disk according to the first and second aspects of the present invention, it is possible to improve the reliability of the address information even when the track pitch is decreased in order to realize the large capacity.

According to a third aspect of the present invention, there is provided an optical disk comprising:
a substrate which is formed with a plurality of grooves; and
a recording layer which is provided on the substrate and which is formed of a phase-change material containing Bi, Ge, and Te, wherein;
header sections are provided for the plurality of grooves respectively, address information of each of the grooves is recorded on one of the header sections of the grooves by deflecting the grooves in a radial direction, and a header section of a certain groove of the grooves and a header section of an adjoining groove to the certain groove are arranged and deviated from each other in a circumferential direction.

According to a fourth aspect of the present invention, there is provided an optical disk comprising:
a substrate which is formed with a plurality of grooves; and
a recording layer which is provided on the substrate and which is formed of a phase-change material containing Bi of not more than 28 atomic %, wherein:
header sections are provided for the plurality of grooves respectively, address information of each of the grooves is recorded on one of the header sections of the grooves by deflecting the grooves in a radial direction, and a header section of a certain groove of the grooves and a header section of an adjoining groove to the certain groove are arranged and deviated from each other in a circumferential direction.

FIG. 6 (FIGS. 6A and 6B) shows an example of the optical disk according to the third and fourth aspects of the present invention. In the case of the optical disk shown in FIG. 6, the data information (recording mark) is recorded on the land, and the address information of each of the tracks is formed by wobbling the groove in the radial direction. As shown in FIG. 6, the address areas (header sections), which are formed on the respective tracks, are formed while being deviated from each other in the circumferential direction. Specifically, as shown in FIG. 6, the address information A(k) of the kth track shown in FIG. 6 is recorded in the first address area, and the address information A(k−1) and the address information A(k+1) of the (k−1)th and (k+1)th tracks adjoining the kth track are formed in the second address area. In the case of the optical disk shown in FIG. 6, one track is constructed by one set of the groove and the land which are adjacent to one another, and the groove and the land are designated by the same track number. That is, in the case of the optical disk shown in FIG. 6, the address information formed in the groove is the address information of the track which includes the groove.

In the case of the optical disk as shown in FIG. 6, for example, when the kth land is scanned across the light beam in the direction of the broken line arrow shown in FIG. 6A to reproduce the address information, then the address information A(k) of the kth track is firstly detected from the left side with respect to the traveling direction of the light beam, and the address information A(k+1) of the (k+1)th track is subsequently detected from the right side with respect to the traveling direction of the light beam (see FIG. 6B). Therefore, when the kth land is scanned across the light beam, even if the address information A(k) of the kth track cannot be reproduced, it is known that the address information on the land subjected to the scanning across the light beam is A(k), on condition that the address information A(k+1) of the (k+1)th track is obtained from the right side with respect to the traveling direction of the light beam. In the case of the optical disk as shown in FIG. 6, even when the address information of the predetermined track cannot be reproduced, the address information of the predetermined land can be reproduced without moving the light beam to the adjoining track. Therefore, it is possible to reproduce the address information more easily. Therefore, in the case of the optical disk according to the third and fourth aspects of the present invention, it is possible to improve the reliability of the address information even when the track pitch is decreased in order to realize the large capacity.

In the optical disk according to the third aspect of the present invention, the recording layer is formed of the phase-change material containing Bi, Ge, and Te in the same manner as in the optical disk according to the first aspect. Therefore, the sufficient quality of the data signal is obtained even when the deflection amount of the wobble of the header section for forming the address information is increased to some extent. Further, even when the data information is repeatedly rewritten, it is possible that the deterioration of the signal quality is suppressed to be small. Therefore, in the case of the optical disk according to the third aspect of the present invention, the reliability of the address information is not only improved, but the repeated rewriting characteristic of the data information can be also improved.

In the optical disk according to the fourth aspect of the present invention, the recording layer is formed of the phase-change material containing Bi and containing the compound based on at least one of the crystalline systems of the cubic system and the tetragonal system in the same manner as in the optical disk according to the second embodiment. Therefore, the sufficient quality of the data signal is obtained even when the deflection amount of the wobble of the header section for forming the address information is increased to some extent. Further, even when the data information is repeatedly rewritten, it is possible that the deterioration of the signal quality is suppressed to be small. Therefore, in the case of the optical disk according to the fourth aspect of the present invention, the reliability of the address information is not only improved, but the repeated rewriting characteristic of the data information can be also improved. The phase-change material for the recording layer may contain Te. In particular, the phase-change material for the recording layer may contain Ge and Te. Further, the phase-change material for the recording layer may have at least one of crystalline systems of a cubic system and a tetragonal system.

In the case of the optical disk according to the first to fourth aspects of the present invention, the data information may be recorded on at least one of the groove and the land between the grooves.

In the case of the optical disk according to the first to fourth aspects of the present invention, the following relationship may hold among a track pitch TP of the optical disk, a wavelength λ of a recording and reproducing light beam, and a numerical aperture NA of a light-collecting lens, and the wavelength λ may be 390 nm to 420 nm:
0.35×(λ/NA)≦TP≦0.7×(λ/NA).

The words “track pitch” mean a distance between tracks adjacent to each other. In a groove recording optical disk in which information is recorded on grooves, the track pitch means a distance between a center of a groove and a center of an adjacent groove thereto. In a land recording optical disk in which information is recorded on lands, the track pitch means a distance between a center of a land and a center of an adjacent land thereto. In a land-groove recording optical disk in which information is recorded on grooves and lands, the track pitch means a half of a distance between a center of a groove and a center of an adjacent groove thereto. In the case of the optical disk according to the first to fourth aspects of the present invention, the data information may be recorded on both of the groove and the land between the grooves.

In the optical disk according to the first to fourth aspects of the present invention, a composition ratio of Bi, Ge, and Te contained in the recording layer may be represented by ((GeTe)ₓ(Bi₂Te₃)₁₋ₓ)_{1-y}Ge_{y}, and 0.3≦x<1 and 0<y≦0.4 may hold for x and y respectively.

In the case of the optical disk according to the first to fourth aspects of the present invention, it is preferable to use the laser beam having a wavelength of 390 nm to 420 nm. The laser beam as described above has the short wavelength as compared with the laser beam having a wavelength of 650 nm having been hitherto used for DVD. Therefore, it is possible to realize a larger capacity. However, if the beam diameter is more focused in order to realize the large capacity, an inconvenience has arisen such that the energy density is increased at the center of the laser beam spot as compared with the conventional technique, and the damage on the optical disk is increased when the data information is repeatedly rewritten. However, in the optical disk according to the first to fourth aspects of the present invention, the composition ratio of Bi, Ge, and Te contained in the recording layer is ((GeTe)ₓ(Bi₂Te₃)₁₋ₓ)_{1-y}Ge_{y} provided that 0.3≦x<1 and 0<y≦0.4 hold. Thus, the problem as described above has been dissolved. The following fact has been revealed. That is, when the Bi—Ge—Te-based phase-change material, which has the composition range as described above, is used as the recording layer, then it is possible to suppress the deterioration of the signal quality which would be otherwise caused by the repeated rewriting of the data information, and it is possible to use the laser beam having the short wavelength.

When both of the groove and the land between the grooves are used as the recording track, it is possible to realize the recording at higher densities. However, in this case, the recording mark width is somewhat narrower than the land width and the groove width. Therefore, the following problem arises. That is, the “band” of the recrystallization, which is generated by the rewriting of the data information performed many times as described above, is generated in the vicinity of the boundary between the land and the groove, and the data signal quality is deteriorated. In particular, the problem as described above conspicuously appears when track pitch is narrowed. However, in the optical disk according to the first to fourth aspects of the present invention, the composition ratio of Bi, Ge, and Te contained in the recording layer is ((GeTe)ₓ(Bi₂Te₃)₁₋ₓ)_{1-y}Ge_{y} provided that 0.3≦x<1 and 0<y≦0.4 hold. Accordingly, the influence of the “band” of the recrystallization, which is caused by the rewriting of the data information performed many times, is decreased. Further, it is possible to suppress the deterioration of the header signal quality even when the land-groove recording is adopted. A further explanation will be made below about the phase-change material to be used for the recording layer of the optical disk according to the first to fourth aspects of the present invention.

In the optical disk according to the first and third aspects of the present invention, the recording layer is formed of the phase-change material containing Bi, Ge, and Te.

In the optical disk according to the second and fourth aspects of the present invention, the recording layer is formed of the phase-change material which contains Bi and which contains the compound based on the crystalline system of the cubic system and/or the tetragonal system. The inventors have investigated various compounds of the cubic system or the tetragonal system containing Bi. AS a result, it has been found out that the compounds bring about the acceleration of the velocity of the crystalline nucleus generation. When the velocity of the crystalline nucleus generation is accelerated, then the number of formed nuclei is increased in the crystallization process, and consequently the crystal grain diameter is hardly increased. That is, the crystal grain diameter is decreased in the recrystallization area which is formed just outside the recording mark. The variation of the reflectance, which would be otherwise caused by the difference in grain diameter, can be decreased, and it is possible to reduce the harmful influence on the header signal. Further, the BiTe-based compound is preferred as the compound based on the cubic system or the tetragonal system containing Bi. In particular, Bi₂Te₃ is most preferred. When Bi₂Te₃ is added to a phase-change material which has a relatively slow velocity of the crystal growth, it is possible to obtain a phase-change material which has a large velocity of the crystalline nucleus generation and a small velocity of the crystal growth. When such a material is used, it is possible to further decrease the width the recrystallization area around the recording mark. This tact may be explained as follows. The recrystallization area is generated in a temperature area which is just below the melting point and in which the crystal growth is dominant, when the surroundings of the melted area are cooled from the melting point. Therefore, as the velocity of the crystal growth is smaller, it is possible to decrease the recrystallization area. When the velocity of the crystal growth is small, a fear remains such that the entire recording mark cannot be recrystallized at a high velocity in order to erase the data. However, when the velocity of the crystalline nucleus generation is large, and a large number of nuclei are formed, then it is possible to perform the crystallization at a high velocity. As a result of the various investigations about the phase-change material performed by the inventors, it has been found out that GeTe-based material is most suitable.

In relation to the recording layer formed of the Bi—Ge—Te-based phase-change material, as disclosed in an exemplary conventional technique (for example, Japanese Patent Application Laid-open No. 62-209741), the practical composition range exists in the area obtained by connecting GeTe and Bi₂Te₃ in the triangular composition diagram having the apexes of Bi, Ge, and Te. However, the inventors have found out the following fact by performing a verifying experiment. When the recording layer is formed of a phase-change material in an area in which Ge is added excessively as compared with those disposed on the line to connect GeTe and Bi₂Te₃, it is possible to obtain the optical disk in which the signal quality is satisfactory and which has the more excellent durability with respect to the repeated rewriting of the data information. The reason of this fact is considered as follows.

Within a range having been revealed at present, the Bi—Ge—Te-based material includes compounds of GeTe, Bi₂Te₃, Bi₂Ge₃Te₆, Bi₂GeTe₄, and Bi₄GeTe₇. Although the situation differs depending on the composition of the Bi—Ge—Te-based material, when the recrystallization occurs immediately after being melted by radiating the light beam onto the recording layer, the recrystallization is considered to be caused from the outer edge portion of the melted area in an order starting from those having the high melting points of Bi, Ge, Te, and the compounds as described above. These substances are listed below in an order starting from those having the high melting points.
Ge: about 937° C.;
GeTe: about 725° C.;
Bi₂Ge₃Te₅: about 6509° C.;
Bi₂Te₃: about 590° C.;
Bi₂GeTe₄: about 584° C.;
Bi₄GeTe₇: about 564° C.;
Te: about 450° C.;
Bi: about 271° C.

That is, Ge has the highest melting point. Therefore, it is considered that Ge tends to be segregated at the outer edge portion of the melted area (recording mark) of the recording layer, in the case of the recording layer formed of the Bi—Ge—Te-based phase-change material to which Ge is added excessively as compared with those disposed on the line to connect GeTe and Bi₂Te₃ of the triangular composition diagram having the apexes of Bi, Ge, and Te. When Ge exists excessively at the outer edge portion of the melted area, then the crystallization velocity is slow at the outer edge portion of the melted area, and the recrystallization from the outer edge portion is consequently suppressed. As a result, it is considered that the occurrence of the “band” of the recrystallization, which would be otherwise caused by the rewriting of the data information performed many times, can be suppressed. Simultaneously with the phenomenon as described above, the material having the lower melting point tends to be segregated in the vicinity of the center of the track (recording mark). Therefore, the crystallization velocity is high, and it is possible to obtain the satisfactory erasing performance even when the high speed recording is performed. However, if Ge is added too excessively, the crystallization velocity is lowered. Therefore, it is important to add an appropriate amount of Ge.

In view of the storage life of the recording mark in the amorphous state, it is important for the material for forming the recording layer that the phase of the amorphous state is not present plurally, the crystallization temperature of the recording layer material is high, and the activation energy is large when the amorphous portion is crystallized. The inventors have found out the fact that the foregoing conditions are satisfied with the composition in the vicinity of Ge₅₀Te₅₀ in the triangular composition diagram having the apexes of Bi, Ge, and Te. One of the causes of this fact is considered as follows as disclosed in the exemplary conventional technique as well. That is, the crystallization temperature of GeTe is about 200° C. which is high, and the crystallization temperature is lowered as the composition approaches Bi₂Te₃.

Further, according to a verifying experiment, the inventors have found out the fact that the amorphous state is hardly changed in the vicinity of Ge₅₀Te₅₀ even after the long term storage, and it is possible to obtain the satisfactory erasing characteristic. However, the following fact has been found out. That is, if the amount of GeTe is too large, then the crystallization velocity is lowered, and it is impossible to perform the high speed recording. If the amount of Bi₂Te₃ is too large, the storage life is deteriorated, because the crystallization temperature is lowered. Therefore, as for the optimum composition for the material for the recording layer, it is satisfactory to use the Bi—Ge—Te-based material in the area in which an appropriate amount of Bi Te, is added to Ge₅₀Te₅₀, and Ge is present excessively. Specifically, the inventors have found out the following fact. That is, it is enough that the recording layer is formed by using the phase-change material having the composition in which the composition ratio of Bi, Ge, and Te satisfies ((GeTe)ₓ(Bi₂Te₃)₁₋ₓ)_{1-y}Ge_{y} provided that 0.3≦x<1 and 0<y≦0.4 hold. When the nucleus generation layer, which contains, for example, Bi₂Te₃, SnTe, and PbTe, is provided adjacently to the recording layer, it is possible to further improve the effect of suppressing the recrystallization. In the case of the optical disk of the present invention, on condition that the recording layer material maintains the relationship within the composition range as described above, the effect of the present invention is not lost even when any impurity is mixed provided that the atomic % of the impurity is within 1%.

In the optical disk according to the first to fourth aspects of the present invention, it is preferable that the reflectance of the recorded portion of the data information formed in the recording layer is lower than the reflectance of the non-recorded portion. It is preferable that the reflectance of the non-recorded portion is not less than 10%. Accordingly, it is possible to further raise the signal level of the address information recorded by deflecting the groove or the land (between the grooves) in the radial direction of the optical disk.

In the optical disk according to the first to fourth aspects of the present invention, the optical disk may further comprise a protective layer, an intermediate layer, and a heat-diffusing layer, wherein the protective layer, the recording layer, the intermediate layer, and the heat-diffusing layer may be provided in this order from a side into which a recording and reproducing light beam comes, the protective layer may have a thickness of 40 nm to 80 nm, the recording layer may have a thickness of 5 nm to 25 nm, the intermediate layer may have a thickness of 30 nm to 60 nm, and the heat-diffusing layer may have a thickness of 30 nm to 300 nm.

In the optical disk according to the first to fourth aspects of the present invention, the thickness of the intermediate layer may be larger than 0.8 time the value of the depth of the groove.

When the optical disk is manufactured in accordance with the film construction as described above, it is possible to suppress the cross-erase which would be otherwise caused such that a part of the data information of the track adjoining the predetermined track disappears when the data information is recorded on the predetermined track. This construction is effective when the track pitch is narrowed. Further, this construction is especially effective when both of the groove and the land (between the grooves) are used as the recording track.

The cross-erase is such a phenomenon that the heat is spread in the radial direction of the disk when the information is recorded on the predetermined track, and thus the recording mark in the amorphous state, which has been already recorded on the adjoining track, is heated, resulting in the crystallization of a part of the recording mark. This phenomenon appears conspicuously when the track pitch is narrowed in order to realize the large capacity. In particular, when both of the groove and the land between the grooves are used as the recording track, the cross-erase of the groove (phenomenon in which a part of the amorphous mark, which is recorded on the adjoining groove, is crystallized when the recording is performed on the land) is enhanced.

The cause of the appearance of the cross-erase is considered to involve the following two causes.
(1) When the recrystallization area around the mark, which is formed when the recording mark in the amorphous state is formed, is large, it is necessary to melt the area having a wider width in order to form the recording mark having a predetermined width. As a result, the heat is greatly spread to the adjoining track, and the cross-erase appears.
(2) In the case of the optical disk based on the land-groove recording in which at least the respective layers of the protective layer, the recording layer, the intermediate layer, and the heat-diffusing layer are provided in this order from the side into which the light beam comes, the recording layer on the land and the heat-diffusing layer on the adjoining groove have approximately the same height due to the difference in height of the groove. Therefore, the heat on the land tends to be spread from the recording layer on the land toward the heat-diffusing layer on the adjoining groove. As a result, the heat, which leaks from the land to the groove, is increased, and the cross-erase of the groove is increased.

The cross-erase due to the cause (1) as described above can be dissolved by suppressing the recrystallization of the recording layer by forming the recording layer with the phase-change material containing Bi, Ge, and Te to satisfy the composition formula as described above. As for the cross-erase due to the cause (2) as described above, it is enough that the recording layer on the land and the heat-diffusing layer on the adjoining groove are not disposed at the same height. The following film construction is available for the optical disk in order to realize this requirement. That is, the optical disk may be formed such that at least the protective layer, the recording layer, the intermediate layer, and the heat-diffusing layer are provided in this order from the side into which the recording and reproducing laser beam comes, and the thickness of the intermediate layer is larger than 0.8 time the groove depth.

Further, in the case of the optical disk based on the land-groove recording, it is necessary to suppress the phenomenon, i.e., the crosstalk in which the data information of the adjoining track causes leakage and mixing when the data information of the predetermined track is reproduced. For this purpose, it is known that the groove depth is appropriately about λ/5n to λ/7n provided that λ represents the laser beam wavelength, and n represents the refractive index of the base material existing on the light-incoming side (see, for example, Japanese Patent NO. 2697555, and Miyagawa et al., “Land and Groove Recording for High Track Density on Phase-change optical Disk”, Jpn. J. Appl. Phys. Vol. 32 (1993), pp. 5324-5328). Therefore, when the laser beam having a wavelength of 405 nm is used, and a plastic material of n=about 1.6 is used as the base material, then the groove depth, which cancels the crosstalk, is about 36 to 51 nm. In the case of this groove depth, in order that the thickness of the intermediate layer is 0.8 time the groove depth, it is necessary that the thickness of the intermediate layer is about 29 to 41 nm at the minimum. When the thickness of the intermediate layer is thicker than this value, it is possible to reduce the cross-erase.

In the optical disk according to the first to fourth aspects of the present invention, a material for forming the intermediate layer may contain, by not less than 25%, a material which has a refractive index of not more than 1.7 at a wavelength λ of the recording and reproducing light beam and which has an extinction coefficient of not more than 0.1. In particular, the material for forming the intermediate layer may contain at least one of SiO₂ and Al₂O₃.

The performance, which is required for the intermediate layer of the optical disk of the present invention, is that the intermediate layer is transparent with respect to the recording and reproducing laser beam wavelength, and the intermediate layer is stable even at a high temperature at which the recording layer is melted. A variety of materials are known for this requirement. Those having been hitherto investigated include, for example, oxides, nitrides, carbides, sulfides, selenides, and mixtures thereof. AS for the thickness of the intermediate layer, in order to suppress the cross-erase, it is necessary to provide the thickness having the large value which is larger than 0.8 time the groove depth as described above. Simultaneously, in order that the sufficient reflectance can be secured, and the large contrast can be provided between the crystalline state and the amorphous state in the recording layer, it is necessary to effect the optical optimization. In the case of the optical disk based on the land-groove recording, it is also necessary that the signal quality of the land is equivalent to that of the groove.

As a result of the investigation about the various materials as described above by the inventors, the following fact has been found out. That is, when the material, which has the refractive index of not more than 1.7 and which contains, by not less than 25%, the material having the extinction coefficient of not more than 0.1, is used for the intermediate layer, then the reflectance and the contrast are not deteriorated, and it is possible to suppress the difference in the signal quality between the land and the groove to be small, even when the thickness of the intermediate layer is larger than 0.8 time the groove depth in order to reduce the cross-erase.

If the intermediate layer is formed of a material having a large refractive index which contains, by not less than 75%, a material having a refractive index larger than 1.7, any one of or all of the phenomena have appeared, including the decrease in the reflectance, the decrease in the contrast, and the difference in the characteristic between the land and groove signals, when the thickness is thickened to some extent in order to reduce the cross-erase. On the contrary, if it was intended to suppress the phenomena of the decrease in the reflectance and the decrease in the contrast by thinning the thickness of the intermediate layer while decreasing the difference in the characteristics between the land and groove signals, it was impossible to reduce the cross-erase.

As for the material contained in the material for forming the intermediate layer, it is preferable to use SiO₂ and Al₂O₃ in view of the thermal stability. In particular, in the case of SiO₂, the refractive index is about 1.4 which is small. Therefore, SiO₂ is more preferred in that the thickness of the intermediate layer can be further thickened, and the cross-erase is further decreased. When Al₂O₃ is used, then the medium noise is decreased, and the noise of the recording signal is decreased. In this viewpoint, Al₂O₃ is more preferred.

In the case of the optical disk according to the first to fourth aspects of the present invention, it is possible to make the application to the information-recording medium in which the heat is generated by the radiation of the energy beam, the atomic arrangement is changed by the heat, and the information is recorded in accordance therewith. Therefore, it is also possible to especially make the application to the information-recording medium other than the disk-shaped information-recording medium such as the optical card irrelevant to the shape of the information-recording medium.

In the case of the optical disk according to the first to fourth aspects of the present invention, it is premised that the medium is constructed such that the substrate is arranged on the light-incoming side of the recording layer. However, the present invention is not limited thereto. The substrate may be arranged on the side opposite to the light-incoming side of the recording layer, and a protective member such as a protective sheet, which is thinner than the substrate, may be arranged on the light-incoming side.

According to a fifth aspect of the present invention, there is provided a recording and reproducing apparatus for an optical disk comprising a substrate which is formed with a plurality of grooves, and a recording layer which is provided on the substrate and which is formed of a phase-change material containing Bi, Ge, and Te, wherein header sections are provided for the plurality of grooves respectively, address information of each of the grooves is recorded on one of the header sections of the grooves by deflecting the grooves in a radial direction, and the header sections of the plurality of grooves are arranged and aligned in the radial direction, the recording and reproducing apparatus comprising:
a rotation control unit which rotates the optical disk;
an optical head which radiates a light beam onto the optical disk;
a reproduced signal-processing circuit which reproduces information on the basis of a reproduced signal detected by the optical head; and
an address information-managing unit which manages the address information reproduced by the reproduced signal-processing circuit, wherein:
the address information-managing unit reproduces address information of a predetermined groove of the grooves on the basis of address information of an adjoining groove to the predetermined groove when the address information, which is recorded on the predetermined groove of the optical disk, was failed to be reproduced.

The recording and reproducing apparatus according to the fifth aspect of the present invention is the recording and reproducing apparatus for recording and reproducing the information on the optical disk on which the address information is recorded in accordance with the format as shown in FIG. 2. FIG. 5 shows an example of the recording and reproducing apparatus according to the fifth aspect of the present invention. The recording and reproducing apparatus according to the fifth aspect of the present invention is provided with the address information-managing unit (area 25 surrounded by dashed lines shown in FIG. 5) for specifying the address information of the predetermined track on the basis of the address information of the adjoining track even when the address information is not obtained from the header section of the predetermined track. Therefore, when the header signal quality cannot be secured sufficiently due to the high density recording, and/or even when the header signal quality is deteriorated due to the rewriting of the data information performed many times, then it is possible to reliably reproduce the address information.

As for the recording and reproducing apparatus according to the fifth aspect of the present invention, a plurality of lands may be defined between the plurality of grooves, header sections may be provided for the plurality of lands respectively, address information of each of the lands may be recorded on one of the header sections of the lands by deflecting the lands in a radial direction, and the header sections of the plurality of lands may be arranged and aligned in the radial direction.

The recording and reproducing apparatus is the recording and reproducing apparatus for recording and reproducing the information on the optical disk on which the address information is recorded in accordance with the format as shown in FIG. 7. FIG. 5 shows an example of the recording and reproducing apparatus. The recording and reproducing apparatus is provided with the address information-managing unit (area 25 surrounded by dashed lines shown in FIG. 5) for specifying the address information of the predetermined groove or the land from a plurality of pieces of address information obtained, for example, when the light beam is radiated onto the predetermined groove or the land of the optical disk as shown in FIG. 7, and the information about the detection sequence or the like of the detected pieces of address information (or the information about the detection area). Therefore, even if the address information of the predetermined groove or the land cannot be detected when the light beam is radiated onto the predetermined groove or the land, it is possible to specify the address information of the predetermined groove or the land from the detected remaining address information and the information about the detection sequence or the like. Therefore, when the wobble amount is decreased due to the high density recording and the header signal quality cannot be secured sufficiently and/or even when the header signal quality is deteriorated due to the rewriting of the data information performed many times, then it is possible to reliably reproduce the address information.

According to a sixth aspect of the present invention, there is provided a recording and reproducing apparatus for an optical disk comprising a substrate which is formed with a plurality of grooves, and a recording layer which is provided on the substrate and which is formed of a phase-change material containing Bi, Ge, and Te, wherein header sections are provided for the plurality of grooves respectively, address information of each of the grooves is recorded on one of the header sections of the grooves by deflecting the grooves in a radial direction, and a header section of a certain groove of the grooves and a header section of an adjoining groove to the certain groove are arranged and deviated from each other in a circumferential direction, the recording and reproducing apparatus comprising:
a rotation control unit which rotates the optical disk;
an optical head which radiates a light beam onto the optical disk;
a reproduced signal-processing circuit which reproduces information on the basis of a reproduced signal detected by the optical head; and
an address information-managing unit which manages the address information reproduced by the reproduced signal-processing circuit, wherein:
the address information-managing unit reproduces address information of a predetermined groove of the grooves on the basis of address information of an adjoining groove to the predetermined groove when the address information, which is recorded on the predetermined groove of the optical disk, was failed to be reproduced.

The recording and reproducing apparatus according to the sixth aspect of the present invention is the recording and reproducing apparatus for recording and reproducing the information on the optical disk on which the address information is recorded in accordance with the format as shown in FIG. 6. FIG. 5 shows an example of the recording and reproducing apparatus according to the sixth aspect of the present invention. The recording and reproducing apparatus according to the sixth aspect of the present invention is provided with the address information-managing unit (area 25 surrounded by dashed lines shown in FIG. 5) for specifying the address information of the predetermined track from the two pieces of information obtained, for example, when the light beam is radiated onto the predetermined land between the grooves of the optical disk as shown in FIG. 6, and the information on the detection side (right side or left side) of the address information with respect to the scanning direction of the light beam. Therefore, even if only one address information can be detected when the light beam is radiated onto the predetermined land between the grooves, it is possible to specify the address information of the predetermined track from the detected address information and the information on the detection side. Therefore, when the wobble amount is decreased due to the high density recording and the header signal quality cannot be secured sufficiently, and/or even when the header signal quality is deteriorated due to the rewriting of the data information performed many times, then it is possible to reliably reproduce the address information.

According to a seventh aspect of the present invention, there is provided a method for managing address information for an optical disk comprising a substrate which is formed with a plurality of grooves, and a recording layer which is provided on the substrate and which is formed of a phase-change material containing Bi, Ge, and Te, wherein header sections are provided for the plurality of grooves respectively, address information of each of the grooves is recorded on one of the header sections of the grooves by deflecting the grooves in a radial direction, and the header sections of the plurality of grooves are arranged and aligned in the radial direction, wherein:
address information of a predetermined groove of the grooves is reproduced on the basis of address information of an adjoining groove to the predetermined groove when the address information, which is recorded on the predetermined groove of the optical disk, was failed to be reproduced.

As for the method for managing the address information according to the seventh aspect of the present invention, a plurality of lands may be defined between the plurality of grooves, header sections may be provided for the plurality of lands respectively, address information of each of the lands may be recorded on one of the header sections of the lands by deflecting the lands in a radial direction, and the header sections of the plurality of lands may be arranged and aligned in the radial direction.

According to an eighth aspect of the present invention, there is provided a method for managing address information for an optical disk comprising a substrate which is formed with a plurality of grooves, and a recording layer which is provided on the substrate and which is formed of a phase-change material containing Bi, Ge, and Te, wherein header sections are provided for the plurality of grooves respectively, address information of each of the grooves is recorded on one of the header sections of the grooves by deflecting the grooves in a radial direction, and a header section of a certain groove of the grooves and a header section of an adjoining groove to the certain groove are arranged and deviated from each other in a circumferential direction, wherein:
address information of a predetermined groove of the grooves is reproduced on the basis of address information of an adjoining groove to the predetermined groove when the address information, which is recorded on the predetermined groove of the optical disk, was failed to be reproduced.

In the recording and reproducing apparatus and the method for managing the address information according to the fifth to eighth aspects of the present invention, it is also preferable to use an energy beam such as an electron beam as the energy beam to be radiated onto the optical disk. In this specification, the energy beam is sometimes expressed as the laser beam or the light beam

### BRIEF DESCRIPTION OF THE DRAWINGS

FIG. 1 shows a schematic sectional view illustrating an optical disk manufactured in a first embodiment.

FIG. 2 shows a schematic structure of an address area of the optical disk manufactured in the first embodiment.

FIG. 3 shows the relationship between the wobble pattern and the information to be recorded, wherein FIG. 3A shows the wobble pattern corresponding to the information “0”, FIG. 3B shows the wobble pattern corresponding to the information “1”, and FIG. 3C shows the wobble pattern adopted when 1 bit information is expressed with 5 wobbles.

FIG. 4 shows a schematic structure of an information-recording and reproducing apparatus used to record and reproduce the information on the various optical disks manufactured in the first embodiment.

FIG. 5 shows a schematic arrangement of an information-recording and reproducing apparatus used in a second embodiment.

FIG. 6 shows a schematic structure of an address area of an optical disk manufactured in a third embodiment, wherein FIG. 6A shows a schematic plan view, and FIG. 6B shows the relationship among the signal detected from the address area, the detection position thereof, and the track number.

FIG. 7 shows a schematic structure of an address area of an optical disk manufactured in a fourth embodiment, wherein FIG. 7A shows a schematic plan view, and FIG. 7B shows the relationship among the signal detected from the address area, the detection position thereof, and the track number.

FIG. 8 shows a preferred composition range for the Bi—Ge—Te-based phase-change material to be used for the recording layer of the optical disk of the present invention.

FIG. 9 shows another exemplary embodiment of the optical disk according to the present invention, illustrating a schematic sectional view, wherein the optical disk includes an absorptance control layer.

### DESCRIPTION OF THE PREFERRED EMBODIMENTS

Embodiments of the optical disk and the recording and reproducing apparatus of the present invention will be explained below. However, the present invention is not limited thereto.

### First Embodiment

Optical Disk

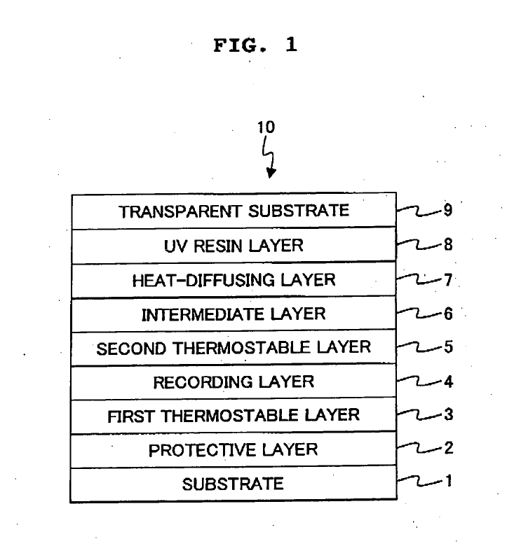

An optical disk based on the phase-change recording system was manufactured in a first embodiment. FIG. 1 shows a schematic sectional view of the land-groove recording optical disk in which information is recorded on grooves and lands manufactured in this embodiment. As shown in FIG. 1, the optical disk 10 manufactured in this embodiment has a structure including a protective layer 2, a first thermostable layer 3, a recording layer 4, a second thermostable layer 5, an intermediate layer 6, a heat-diffusing layer 7, a UV resin layer 8, and a transparent substrate 9 which are successively stacked on a substrate 1. Next, an explanation will be made about a method for manufacturing the optical disk of this embodiment.

At first, the substrate 1 made of polycarbonate having a diameter of 120 mm and a thickness of 0.6 mm was manufactured by the injection molding by using a stamper. In this procedure, grooves, which had a depth of 45 nm, were formed in a recording area of the optical disk having radii from 23.8 mm to 58.6 mm on the substrate 1. A track pitch of the optical disk was 0.34 μm. Wobbles were applied to the groove at a 93 channel bit cycle. In this embodiment, various substrates 1 (10 types) were prepared, in which the wobble amount (Peak to Peak value) with respect to the track pitch was 1.5% to 10%.

Subsequently, (ZnS)₈₀(SiO₂)₂₀ was formed as the protective layer 2 to have a thickness of 58 nm on the substrate 1 by the sputtering. Subsequently, Ge₈Cr₂-N (indicated by a relative ratio) was formed as the first thermostable layer 3 to have a thickness of 1 nm on the protective layer 2 by the sputtering.

Subsequently, the recording layer 4 was formed to have a thickness of 13 nm on the first thermostable layer 3 by means of the spattering. In this process, the recording layer 4 was formed by co-sputtering a Ge-rich Ge₅₀Te₅₀ target and a Bi₂Te₃ target so that the composition of the recording layer 4 was the composition in which Ge was excessive as compared with the composition disposed on the line to connect Ge₅₀Te₅₀ and Bi₂Te₃ in the triangular composition diagram having the apexes of Bi, Ge, and Te, specifically the composition resided in ((GeTe)ₓ(Bi₂Te₃)₁₋ₓ)_{1-y}Ge_{y} provided that 0.3≦x<1 and 0<y≦0.4 held. The recording layer 4 having the desired composition was formed by adjusting the sputtering powers to be applied to the two types of the targets respectively.

In this embodiment, those manufactured as the recording layer 4 included several types of films having compositions on the line of Ge₅₁Te₄₉—Bi₂Te₃ and films having compositions on the line of Bi₄Ge₄₃Te₅₃—Ge in the triangular composition diagram having the apexes of Bi, Ge, and Te.

Specifically, those manufactured as the films having the compositions on the Ge₅₁Te₄₉—Bi₂Te₃ line included six types of Bi₂Ge₄₉Te₄₉, Bi₅Ge₄₅Te₅₀, Bi₁₀Ge₃₈Te₅₂, Bi₁₅Ge₃₂Te₅₃, Bi₂₀Ge₂₆Te₅₄, and Bi₂₅Ge₂₀Te₅₅. For the purpose of comparison, films having compositions of Ge₅₁Te₄₉ and Bi₂₈Ge₁₆Te₃₆ were also manufactured as the films having the compositions on the Ge₅₃Te₄₉—Bi₂Te₃ line outside the range of the compositions as described above.

Those manufactured as the films having the compositions on the Bi₄Ge₄₃Te₅₃—Ge line included three types of Bi₄Ge₄₆Te₅₀, Bi₃Ge₅₀Te₄₇, and Bi₃Ge₅₉Te₃₈. For the purpose of comparison, films having compositions of Bi₄Ge₄₃Te₅₃, and Bi₂Ge₇₀Te₂₈ were also manufactured as the films having the compositions on the Bi₄Ge₄₃Te₅₃—Ge line outside the range of the compositions as described above.

Ge₈Cr₂—N (relative ratio) was formed as the second thermostable layer 5 to have a thickness of 1 nm by the sputtering on the recording layer 4 formed by the method as described above. Subsequently, (ZnS)₅₀(SiO₂)₅₀, was formed as the intermediate layer 6 to have a thickness of 48 nm on the second thermostable layer 5 by the sputtering. Further, Al₉₉Ti₁ was formed as the heat-diffusing layer 7 to have a thickness of 150 nm on the intermediate layer 6 by the sputtering.

Subsequently, an ultraviolet-curable resin was applied as the UV resin layer 8 on the heat-diffusing layer 7. Further, the transparent substrate 9 made of polycarbonate having a thickness of 0.6 mm was placed thereon. The UV radiation was effected through the transparent substrate 9 to cure the ultraviolet-curable resin so that the transparent substrate 9 was stuck onto the UV resin layer 8. According to the production method as described above, the optical disk 10 shown in FIG. 1 was obtained.

The apparatus used for the sputtering in this embodiment had a plurality of sputtering chambers. Eight pieces of the substrates each having a diameter of 120 mm were capable of being simultaneously introduced into one sputtering chamber.

Structure of Header Section

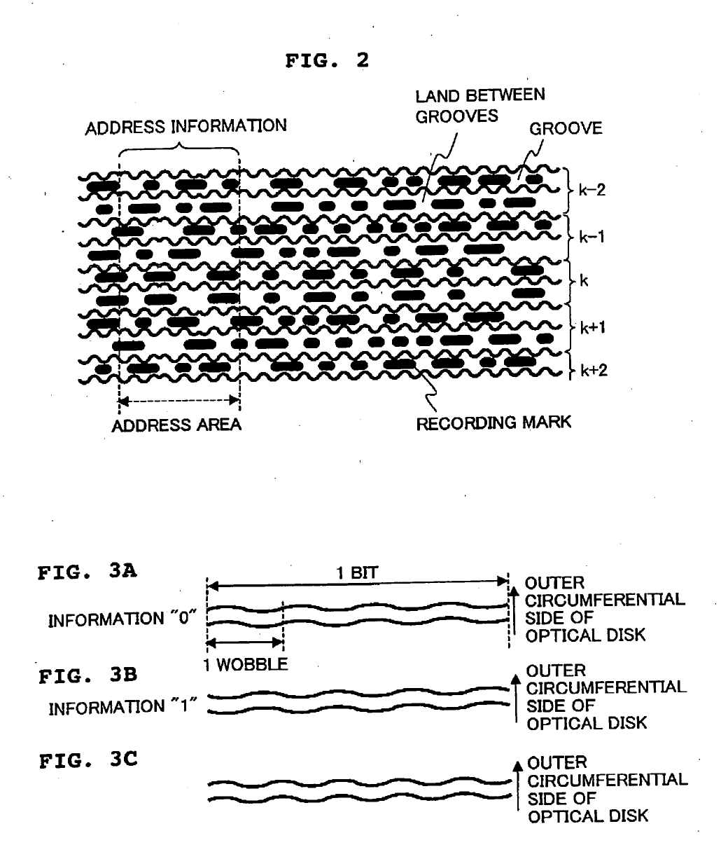

FIG. 2 shows the structure of the grooves and the lands in the vicinity of the header section of the optical disk manufactured in this embodiment. As shown in FIG. 2, the wobbles were applied at a 93 channel bit cycle to the grooves formed in the recording area having radii of 23.8 mm to 58.6 mm of the optical disk manufactured in this embodiment. As described above, in this embodiment, the wobble amount with respect to the track pitch (Peak to Peak value) was 1.5% to 10%.

As shown in FIG. 2, in the case of the optical disk of this embodiment, the address information of the track was formed by changing the wobble pattern in the radial direction of the groove. The header sections (address areas shown in FIG. 2) were arranged so that they were aligned in the radial direction of the optical disk.

As shown in FIG. 2, in the case of the optical disk manufactured in this embodiment, the data information was recorded as recording marks (land-groove recording) on the grooves and the lands in the address area and the areas other than the above. As shown in FIG. 2, in the case of the optical disk of this embodiment, one track was constructed by one set of the groove and the land which were adjacent to one another, and the groove and the land were designated by the same track number. That is, in the case of the optical disk shown in FIG. 2, the address information, which is formed on the groove, is the address information of the track which includes the groove.

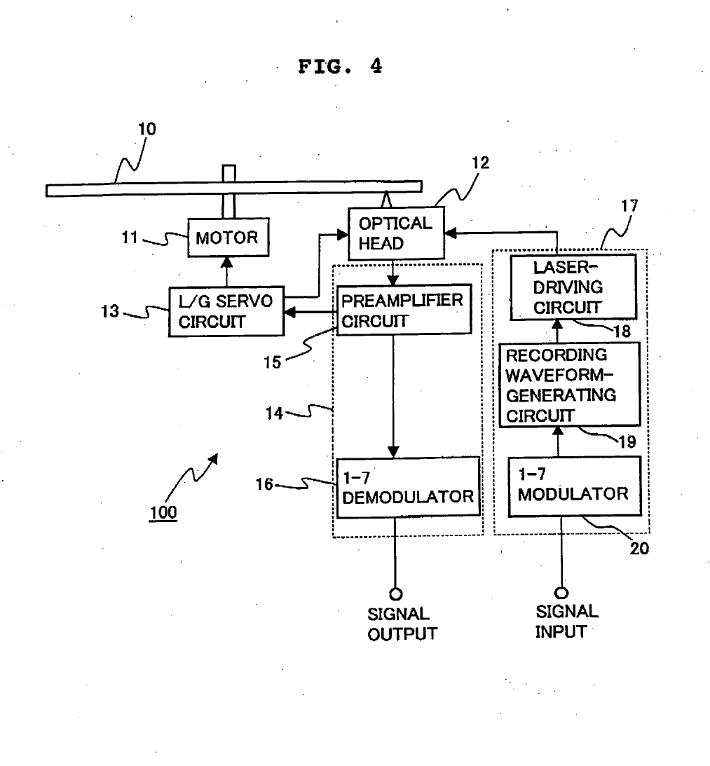

FIG. 3 shows an example of the relationship between the address information and the groove wobble pattern. The groove wobble patterns shown in FIGS. 3A and 3B reside in examples in which 1 bit information is formed with 4 wobbles. The groove wobble pattern shown in FIG. 3C resides in an example in which 1 bit information is formed with 5 wobbles. In the case of the optical disk manufactured in this embodiment, as shown in FIG. 3A, the pattern, in which the groove was deflected toward the outer circumferential side, the inner circumferential side, the outer circumferential side, the inner circumferential side, and the outer circumferential side in the radial direction of the optical disk from the left side of the drawing, corresponded to the information “0”. The groove wobble pattern shown in FIG. 3B, which had the phase opposite to that of the wobble pattern shown in FIG. 3A, corresponded to the information “1”.

In the case of the optical disk manufactured in this embodiment, 1 bit was formed with 2 wobbles. As shown in FIG. 2, the address information of each track was formed with 3 bits (6 wobbles). The address areas were provided every 84 wobbles. As shown in FIG. 2 the address areas were arranged so that they were aligned in the radial direction of the optical disk. Wobbles were formed with the wobble pattern corresponding to the information “0” in almost all areas other than the address areas. However, the wobbles of the wobble pattern corresponding to the information “1” were formed in the area corresponding to 1 bit (area on the left side of the address area shown in FIG. 2) just before the start of the address information.

In the case of the optical disk in which the header sections are constructed with the format as shown in FIG. 2, when the address information of the predetermined groove (track) was failed to be reproduced, the light beam is moved to the adjoining groove to detect the address information of the adjoining groove. The address information of the predetermined groove is specified from the address information of the adjoining groove. In this procedure, in the case of the optical disk manufactured in this embodiment, as shown in FIG. 2, the address areas of the grooves are arranged at the same position in the radial direction. Therefore, the address information of the adjoining groove is obtained by only moving the light beam to the adjoining groove. Therefore, even when the address information of the predetermined groove was failed to be reproduced, the address information of the predetermined groove can be specified quickly and easily from the address information of the adjoining groove.

Information-Recording and Reproducing Apparatus

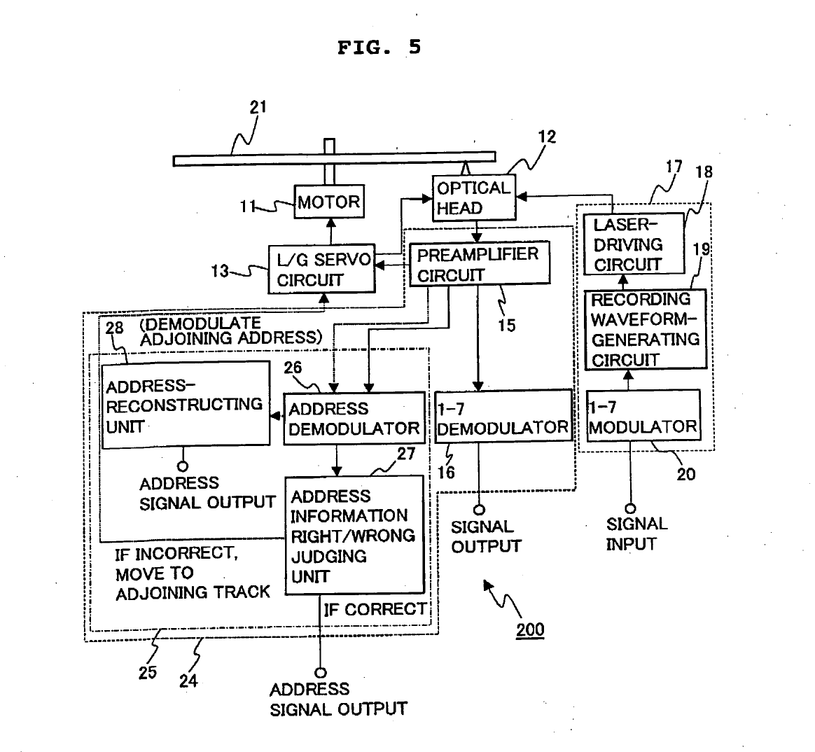

FIG. 4 shows a schematic arrangement of an information-recording and reproducing apparatus for recording and reproducing information on the optical disk manufactured in this embodiment. As shown in FIG. 4, the information-recording and reproducing apparatus 100 used in this embodiment principally includes a motor 11 which rotates the optical disk 10 manufactured in this embodiment, an optical head 12 which radiates the laser beam onto the optical disk 10, an L/G servo circuit 13 which performs the tracking control, a reproduced signal-processing system 14, and a recording signal-processing system 17. As shown in FIG. 4, the reproduced signal-processing system 14 includes a preamplifier circuit 15 which adjusts the gain of the reproduced signal, and a 1-7 demodulator 16 which reproduces information on the basis of the reproduced signal. As shown in FIG. 4, the recording signal-processing system 17 includes a 1-7 modulator 20 which modulates the input signal in accordance with a predetermined modulation system, a recording waveform-generating circuit 19 which generates the recording waveform, and a laser-driving circuit 18 which controls the light emission of the laser beam.

The optical head 12 used in this embodiment is provided with a semiconductor laser having a wavelength of 405 nm, and an objective lens having a numerical aperture NA of 0.65. In general, when the laser beam having a laser wavelength of λ is collected with the objective lens having a numerical aperture NA, the spot diameter of the laser beam is about 0.9×λ/NA. Therefore, in this embodiment, the spot diameter of the laser beam is about 0.6 μm. However, in this embodiment, the polarization of the laser beam was the circular polarization. Further, in this embodiment, the track pitch TP was 0.34 μm. Therefore, the following relationship holds among the track pitch TP, the wavelength λ, and the numerical aperture NA:
TP=0.55×(λ/NA).

The optical disk manufactured in this embodiment is the optical disk based on the land-groove recording system. Therefore, the information-recording and reproducing apparatus 100 shown in FIG. 4 is also adapted to the land-groove recording system. In the case of the information-recording and reproducing apparatus 100 of this embodiment, the L/G servo circuit 13 shown in FIG. 4 can be used to arbitrarily select the tracking for the land and the groove.

An explanation will be made below with reference to FIG. 4 about the operation of the information-recording and reproducing apparatus 100. The ZCLV system, in which the number of revolutions of the disk was changed for every zone to perform the recording and reproduction, was adopted as the method for controlling the motor when the recording and reproduction were performed. In this embodiment, the mark edge system was used when information was recorded. Information was recorded on the optical disk 10 in accordance with the 1-7 modulation system. In this modulation system, information is recorded with mark lengths of 2 T to 8 T. In this embodiment, the recording was performed so that the mark length of the shortest 2 T was about 0.17 μm and the mark length of the longest 8 T was about 0.7 μm. The symbol T herein represents the clock cycle during the information recording. In this embodiment, T=15.4 ns was given.

At first, the signal, which is required for the information recording, is inputted from the outside of the recording apparatus to the 1-7 modulator 20. Subsequently, the signal, which is inputted into the 1-7 modulator 20, is modulated in accordance with the 1-7 modulation system, and the digital signals of 2 T to 8 T are outputted. Subsequently, the digital signals of 2 T to 8 T, which are outputted from the 1-7 modulator 20, are inputted into the recording waveform-generating circuit 19.

In the recording waveform-generating circuit 19, the multi-pulse recording waveform, which is required to radiate the laser during the information recording, is generated on the basis of the digital signals of 2 T to 8 T. In this embodiment, the high power level area of the multi-pulse recording waveform was formed with a series of pulse arrays including high power pulses having a width of about T/2 and low power pulses having a width of about T/2 formed between the high power pulses. The area, which was disposed between the series of arrays of the multi-pulse recording waveform, was constructed with pulses at an intermediate power level. In this procedure, the pulse intensity at the high power level for forming the recording mark (amorphous state) in the recording layer, and the pulse intensity at the intermediate power level for crystallizing the recording mark were adjusted to have optimum values for every optical disk to perform the recording and the reproduction.

In the recording waveform-generating circuit 19, the digital signal waveform of 2 T to 8 T was allowed to alternately correspond to “0” and “1” in a chronological order. In the case of “0”, the laser pulse at the intermediate power level was radiated. In the case of “1”, the series of pulse array, which was composed of the high power pulse and the low power pulse as described above, was radiated. In this procedure, the portion on the optical disk 10, which is irradiated with the intermediate power level laser pulse, is in the crystalline state. The portion, which is irradiated with the series of pulse array including the high power pulse and the low power pulse as described above, is changed to be amorphous (mark portion). Further, the recording waveform-generating circuit 19 has a multi-pulse waveform table which is adapted to the system (adaptive type recording waveform control) for changing the leading pulse width and the trailing pulse width of the multi-pulse waveform depending on the space lengths before and after the mark portion when the series of pulse array composed of the high power pulse and the low power pulse as described above is formed. Accordingly, the multi-pulse recording waveform is generated so that the influence of the intra-mark thermal interference generated between the marks can be excluded as much as possible.

Subsequently, the multi-pulse recording waveform, which is generated by the recording waveform-generating circuit 19, is transferred to the laser-driving circuit 18. The laser-driving circuit 18 controls the light emission of the semiconductor laser included in the optical head 12 on the basis of the inputted multi-pulse recording waveform. The laser beam, which is radiated from the semiconductor laser, is focused onto the recording layer of the optical disk 10 by using the objective lens included in the optical head 12. The laser beam was radiated at the timing corresponding to the multi-pulse recording waveform to record the information.

Next, an explanation will be made about the operation for reproducing the information having been recorded as described above. At first, the laser beam is radiated from the optical head 12 onto the recording mark of the optical disk 10. The reflected light beams, which come from the recording mark portion and the portion other than the recording mark (non-recorded portion), are detected by the optical head 12 to obtain the reproduced signal. The amplitude of the reproduced signal is amplified at a predetermined gain by using the preamplifier circuit 15, which is transferred to the 1-7 demodulator 16. The 1-7 demodulator 16 demodulates the information on the basis of the inputted reproduced signal to output the reproduced data. According to the operation as described above, the reproduction of the recorded mark is completed.

Evaluation of Error Rate

The various optical disks manufactured by the production method described above, i.e., the various optical disks changed with the groove wobble amount of the groove and the composition of the recording layer were installed to the information-recording and reproducing apparatus shown in FIG. 4 respectively to measure the error rates (hereinafter referred to as “error ratio” as well) of the address information and the data information so that the address signal quality and the data signal quality were evaluated. In this embodiment, the error rate of the address information in the non-recorded state (initial state), the error rates of the address information and the data information upon the initial recording, and the error rates of the address information and the data information upon the 1,000 times rewriting were measured. When the error rate of the data information was measured, a random pattern having recording mark lengths of 2 T to 8 T was recorded and reproduced as the data information. Obtained results are shown in Tables 1 to 13. However, the evaluation results in this embodiment are expressed by “++”, “+”, and “−” as shown in Tables 1 to 13. The judgment criteria are as follows.
++: error rate is not more than 5×10⁻⁵;
+: error rate is not more than 1×10⁻⁴;
−: error rate is larger than 1×10⁻⁴;

At first, the measurement results of the various error rates of the optical disks, in which the recording layers had the compositions on the line of Ge₅₁Te₄₉—Bi₂Te₃, are shown in Tables 1 to 8. It is noted that Tables 1 and 8 show the evaluation results of the composition films on the line of Ge₅₁Te₄₉—Bi₂Te₃, and the composition films (Ge₅₁Te₄₉ and Bi₂₈Ge₁₆Te₅₅) have the composition ranges of the recording layers existing outside ((GeTe)ₓ(Bi₂Te₃)₁₋ₓ)_{1-y}Ge_{y} (provided that 0.3≦x<1 and 0<y≦0.4 hold).

TABLE 1
Composition of recording layer: Ge₅₁Te₄₉

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | + | − | + |
| 2.5 | + | − | + | − | − |
| 3 | ++ | + | − | − | − |
| 3.5 | ++ | + | − | − | − |
| 4 | ++ | + | − | + | − |
| 5 | ++ | + | − | + | − |
| 7 | ++ | ++ | − | + | − |
| 10 | ++ | ++ | − | + | − |

As clarified from Table 1, when the composition of the recording layer was Ge₅₁Te₄₉, it was impossible to obtain any optical disk in which the evaluation was not less than the evaluation “+” in relation to all of the evaluation items, within the range of the wobble amount of those manufactured in this embodiment.

TABLE 2
Composition of recording layer: Bi₂Ge₄₉Te₄₉

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | tines |
| amount (%) | recording) | recording) | recording) | rewriting) | rewriting) |
| 1.5 | − | − | ++ | − | ++ |
| 2.5 | + | − | ++ | − | ++ |
| 3 | ++ | + | ++ | + | ++ |
| 3.5 | ++ | ++ | ++ | + | + |
| 4 | ++ | ++ | + | ++ | + |
| 5 | ++ | ++ | + | ++ | + |
| 7 | ++ | ++ | + | ++ | + |
| 10 | ++ | ++ | + | ++ | − |

As clarified from Table 2, when the composition of the recording layer was Bi₂Ge₄₉Te₄₉, it was revealed that the evaluation “+” or more was obtained in relation to all of the evaluation items for the optical disks in which the wobble amount was within a range of 3% to 7%, and the satisfactory error rate characteristics were obtained. Further, as clarified from Table 2, in the case of the optical disks in which the wobble amount was 1.5% to 2.5%, the error rate of the address information was increased because of the small wobble amount, and the evaluation “−” was obtained irrelevant to the number of times of the recording of the data information. On the other hand, in the case of the optical disk in which the wobble amount was 10%, the error rate of the data information was increased due to the large wobble amount and the deterioration of the recording layer caused by the 1,000 times rewriting, and the evaluation “−” was obtained for the error rate upon the 1,000 times rewriting.

TABLE 3
Composition of recording layer: Bi₅Ge₄₅Te₅₀

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | ++ | − | ++ |
| 2.5 | + | − | ++ | − | ++ |
| 3 | ++ | + | ++ | + | ++ |
| 3.5 | ++ | ++ | ++ | + | + |
| 4 | ++ | ++ | + | + | + |
| 5 | ++ | ++ | + | ++ | + |
| 7 | ++ | ++ | + | ++ | − |
| 10 | ++ | ++ | − | ++ | − |

As clarified from Table 3, when the composition of the recording layer was Bi₅Ge₄₅Te₅₀, it was revealed that the evaluation “+” or more was obtained in relation to all of the evaluation items for the optical disks in which the wobble amount was within a range of 3% to 5%, and the satisfactory error rate characteristics were obtained. Further, as clarified from Table 3, in the case of the optical disks in which the wobble amount was 1.5% to 2.5%, the error rate of the address information was increased because of the small wobble amount, and the evaluation “−” was obtained irrelevant to the number of times of the recording of the data information. On the other hand, in the case of the optical disk in which the wobble amount was 7%, the error rate of the data information was increased due to the large wobble amount and the deterioration of the recording layer caused by the 1,000 times rewriting, and the evaluation “−” was obtained for the error rate upon the 1,000 times rewriting. Further, in the case of the optical disk in which the wobble amount was 10%, the error rate was increased due to the too large wobble amount, and the evaluation “−”, was obtained for the error rate of the data information irrelevant to the number of times of the recording of the data information.

TABLE 4
Composition of recording layer: Bi₁₀Ge₃₈Te₅₂

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | ++ | − | ++ |
| 2.5 | + | − | ++ | − | ++ |
| 3 | ++ | + | ++ | + | + |
| 3.5 | ++ | + | + | + | + |
| 4 | ++ | ++ | + | + | + |
| 5 | ++ | ++ | + | + | + |
| 7 | ++ | ++ | − | ++ | − |
| 10 | ++ | ++ | − | ++ | − |

As clarified from Table 4, when the composition of the recording layer was Bi₁₀Ge₃₈Te₅₂, it was revealed that the evaluation “+” or more was obtained in relation to all of the evaluation items for the optical disks in which the wobble amount was within a range of 3% to 5%, and the satisfactory error rate characteristics were obtained. Further, as clarified from Table 4, in the case of the optical disks in which the wobble amount was 1-5% to 2.5%, the error rate of the address information was increased because of the small wobble amount, and the evaluation “−” was obtained irrelevant to the number of times of the recording of the data information. On the other hand, in the case of the optical disks in which the wobble amount was 7% to 10%, the error rate was increased due to the too large wobble amount, and the evaluation “−” was obtained for the error rate of the data information irrelevant to the number of times of the recording of the data information.

TABLE 5
Composition of recording layer: Bi₁₅Ge₃₂Te₅₃

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | ++ | − | ++ |
| 2.5 | + | − | ++ | − | + |
| 3 | ++ | + | + | + | + |
| 3.5 | ++ | + | + | + | + |
| 4 | ++ | + | + | + | + |
| 5 | ++ | ++ | − | + | − |
| 7 | ++ | ++ | − | + | − |
| 10 | ++ | ++ | − | ++ | − |

As clarified from Table 5, when the composition of the recording layer was Bi₁₅Ge₃₂Te₅₃, it was revealed that the evaluation “+” or more was obtained in relation to all of the evaluation items for the optical disks in which the wobble amount was within a range of 3% to 4%, and the satisfactory error rate characteristics were obtained. Further, as clarified from Table 5, in the case of the optical disks in which the wobble amount was 1.5% to 2.5%, the error rate of the address information was increased because of the small wobble amount, and the evaluation “−” was obtained irrelevant to the number of times of the recording of the data information. On the other hand, in the case of the optical disks in which the wobble amount was 5% to 10%, the error rate was increased due to the too large wobble amount, and the evaluation “−” was obtained for the error rate of the data information irrelevant to the number of times of the recording of the data information.

TABLE 6
Composition of recording layer: Bi₂₀Ge₂₆Te₅₄

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | ++ | − | + |
| 2.5 | + | − | + | − | + |
| 3 | ++ | + | + | + | + |
| 3.5 | ++ | + | + | + | + |
| 4 | ++ | + | + | + | − |
| 5 | ++ | + | − | + | − |
| 7 | ++ | + | − | + | − |
| 10 | ++ | ++ | − | + | − |

As clarified from Table 6, when the composition of the recording layer was Bi₂₀Ge₂₆Te₅₄, it was revealed that the evaluation “+” or more was obtained in relation to all of the evaluation items for the optical disks in which the wobble amount was within a range of 3% to 3.5%, and the satisfactory error rate characteristics were obtained. Further, as clarified from Table 6, in the case of the optical disks in which the wobble amount was 1.5% to 2.5%, the error rate of the address information was increased because of the small wobble amount, and the evaluation “−” was obtained irrelevant to the number of times of the recording of the data information. On the other hand, in the case of the optical disk in which the wobble amount was 4%, the error rate of the data information was increased due to the large wobble amount and the deterioration of the recording layer caused by the rewriting 1,000 times, and the evaluation “−” was obtained for the error rate upon the rewriting 1,000 times. Further, in the case of the optical disks in which the wobble amount was 5% to 10%, the error rate was increased due to the too large wobble amount, and the evaluation “−” was obtained for the error rate of the data information irrelevant to the number of times of the recording of the data information.

TABLE 7
Composition of recording layer: Bi₂₅Ge₂₀Te₅₅

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | + | − | + |
| 2.5 | + | − | + | − | + |
| 3 | ++ | + | + | + | + |
| 3.5 | ++ | + | + | + | − |
| 4 | ++ | + | − | + | − |
| 5 | ++ | + | − | + | − |
| 7 | ++ | + | − | + | − |
| 10 | ++ | + | − | + | − |

As clarified from Table 7, when the composition of the recording layer was Bi₂₅Ge₂₀Te₅₅, it was revealed that the evaluation “+” or more was obtained in relation to all of the evaluation items for the optical disk in which the wobble amount was 3%, and the satisfactory error rate characteristics were obtained. Further, as clarified from Table 7, in the case of the optical disks in which the wobble amount was 1.5% to 2.5%, the error rate of the address information was increased because of the small wobble amount, and the evaluation “−” was obtained irrelevant to the number of times of the recording of the data information. On the other hand, in the case of the optical disk in which the wobble amount was 3.5%, the error rate of the data information was increased due to the large wobble amount and the deterioration of the recording layer caused by the rewriting 1,000 times, and the evaluation “−” was obtained for the error rate upon the rewriting 1,000 times. Further, in the case of the optical disks in which the wobble amount was 4% to 10%, the error rate was increased due to the too large wobble amount, and the evaluation “−” was obtained for the error rate of the data information irrelevant to the number of times of the recording of the data information.

TABLE 8
Composition of recording layer: Bi₂₈Ge₁₅Te₅₆

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | + | − | + |
| 2.5 | + | − | + | − | + |
| 3 | ++ | − | + | − | − |
| 3.5 | ++ | + | − | − | − |
| 4 | ++ | + | − | + | − |
| 5 | ++ | + | − | + | − |
| 7 | ++ | + | − | + | − |
| 10 | ++ | + | − | + | − |

As clarified from Table 8, when the composition of the recording layer was Bi₂₈Ge₁₆Te₅₆, it was impossible to obtain any optical disk in which the evaluation was not less than the evaluation “+” in relation to all of the evaluation items, within the range of the wobble amount of those manufactured in this embodiment.

Next, the measurement results of the various error rates of the optical disks, in which the recording layers had the compositions on the line of Bi₄Ge₄₃Te₅₃—Ge, are shown in Tables 9 to 13. It is noted that Tables 9 and 13 show the evaluation results of the composition films on the line of Bi₄Ge₄₃Te₅₃—Ge, and the composition films (Bi₄Ge₄₃Te₅₃ and Bi₂Ge₇₀Te₂₈) have the composition ranges of the recording layers existing outside ((GeTe)ₓ(Bi₂Te₃)₁₋ₓ)_{1-y}Ge_{y} (provided that 0.3≦x<1 and 0<y≦0.4 hold).

TABLE 9
Composition of recording layer: Bi₄Ge₄₃Te₅₃

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | ++ | − | + |
| 2.5 | + | − | ++ | − | + |
| 3 | ++ | + | ++ | − | + |
| 3.5 | ++ | ++ | + | + | − |
| 4 | ++ | ++ | + | ++ | − |
| 5 | ++ | ++ | + | ++ | − |
| 7 | ++ | ++ | − | ++ | − |
| 10 | ++ | ++ | − | ++ | − |

As clarified from Table 9, when the composition of the recording layer was Bi₄Ge₄₃Te₅₃, it was impossible to obtain any optical disk in which the evaluation was not less than the evaluation “+” in relation to all of the evaluation items, within the range of the wobble amount of those manufactured in this embodiment.

TABLE 10
Composition of recording layer: Bi₄Ge₄₆Te₅₀

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | ++ | − | ++ |
| 2.5 | + | − | ++ | − | ++ |
| 3 | ++ | + | ++ | + | ++ |
| 3.5 | ++ | ++ | + | + | + |
| 4 | ++ | ++ | + | ++ | + |
| 5 | ++ | ++ | + | ++ | + |
| 7 | ++ | ++ | + | ++ | + |
| 10 | ++ | ++ | + | ++ | − |

As clarified from Table 10, when the composition of the recording layer was Bi₄Ge₄₆Te₅₀, it was revealed that evaluation “+” or more was obtained in relation to all of the evaluation items for the optical disks in which the wobble amount was within a range of 3% to 7%, and the satisfactory error rate characteristics were obtained. Further, as clarified from Table 10, in the case of the optical disks in which the wobble amount was 1.5% to 2.5%, the error rate of the address information was increased because of the small wobble amount, and the evaluation “−” was obtained irrelevant to the number of times of the recording of the data information. On the other hand, in the case of the optical disk in which the wobble amount was 10%, the error rate of the data information was increased due to the large wobble amount and the deterioration of the recording layer caused by the 1,000 times rewriting, and the evaluation “−” was obtained for the error rate upon the 1,000 times rewriting.

TABLE 11
Composition of recording layer: Bi₃Ge₅₀Te₄₇

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | ++ | − | ++ |
| 2.5 | + | − | ++ | − | ++ |
| 3 | ++ | + | ++ | + | + |
| 3.5 | ++ | ++ | + | + | + |
| 4 | ++ | ++ | + | ++ | + |
| 5 | ++ | ++ | + | ++ | − |
| 7 | ++ | ++ | + | ++ | − |
| 10 | ++ | ++ | − | ++ | − |

As clarified from Table 11, when the composition of the recording layer was Bi₃Ge₅₀Te₄₇, it was revealed that the evaluation “+” or more was obtained in relation to all of the evaluation items for the optical disks in which the wobble amount was within a range of 3% to 4%, and the satisfactory error rate characteristics were obtained. Further, as clarified from Table 11, in the case of the optical disks in which the wobble amount was 1.5% to 2.5%, the error rate of the address information was increased because of the small wobble amount, and the evaluation “−” was obtained irrelevant to the number of times of the recording of the data information. On the other hand, in the case of the optical disks in which the wobble amount was 5% to 7%, the error rate of the data information was increased due to the large wobble amount and the deterioration of the recording layer caused by the 1,000 times rewriting, and the evaluation “−” was obtained for the error rate upon the 1,000 times rewriting. Further, in the case of the optical disk in which the wobble amount was 10%, the error rate was increased due to the too large wobble amount, and the evaluation “−” was obtained for the error rate of the data information irrelevant to the number of times of the recording of the data information.

TABLE 12
Composition of recording layer: Bi₃Ge₃₉Te₃₈

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | ++ | − | + |
| 2.5 | + | − | ++ | − | + |
| 3 | ++ | + | + | + | + |
| 3.5 | ++ | + | + | + | − |
| 4 | ++ | + | + | + | − |
| 5 | ++ | + | − | + | − |
| 7 | ++ | + | + | + | − |
| 10 | ++ | ++ | − | ++ | − |

As clarified from Table 12, when the composition of the recording layer was Bi₃Ge₅₉Te₃₈, it was revealed that the evaluation “+” or more was obtained in relation to all of the evaluation items for the optical disk in which the wobble amount was 3%, and the satisfactory error rate characteristics were obtained. Further, as clarified from Table 12, in the case of the optical disks in which the wobble amount was 1.5% to 2.5%, the error rate of the address information was increased because of the small wobble amount, and the evaluation “−” was obtained irrelevant to the number of times of the recording of the data information On the other hand, in the case of the optical disks in which the wobble amount was 3.5%, 4%, and 7%, the error rate of the data information was increased due to the large wobble amount and the deterioration of the recording layer caused by the 1,000 times rewriting, and the evaluation “−” was obtained for the error rate upon the 1,000 times rewriting. Further, in the case of the optical disks in which the wobble amount was 5% and 10%, the error rate was increased due to the too large wobble amount, and the evaluation “−” was obtained for the error rate of the data information irrelevant to the number of times of the recording of the data information.

TABLE 13
Composition of recording layer: Bi₂Ge₇₀Te₂₈

| | | | | Address | Data error |
|---|---|---|---|---|---|
| | Address | Address | Data error | error rate | rate |
| | error rate | error rate | rate | (1,000 | (1,000 |
| Wobble | (non- | (initial | (initial | times | times |
| amount (%) | recording) | recording) | recording) | rewriting) | rewriting) |
| 1.5 | − | − | + | − | + |
| 2.5 | + | − | + | − | + |
| 3 | ++ | − | + | − | + |
| 3.5 | ++ | + | + | − | − |
| 4 | ++ | + | − | + | − |
| 5 | ++ | + | − | + | − |
| 7 | ++ | + | − | + | − |
| 10 | ++ | + | − | + | − |

As clarified from Table 13, when the composition of the recording layer was Bi₂Ge₇₀Te₂₈, it was impossible to obtain any optical disk in which the evaluation was not less than the evaluation “+” in relation to all of the evaluation items, within the range of the wobble amount of those manufactured in this embodiment.

As clarified from Tables 1 to 13 described above, the following fact has been revealed. That is, in the case of the optical disks (optical disks shown in Tables 2 to 8 and Tables 10 to 12) in which the composition of the recording layer is the composition containing excessive Ge as compared with the composition on the line to connect Ge₅₀Te₅₀ and Bi₂Te₃ in the triangular composition diagram having the apexes of Bi, Ge, and Te, specifically ((GeTe)ₓ(Bi₂Te₃)₁₋ₓ)_{1-y}Ge_{y} is given provided that 0.3≦x<1 and 0<y≦0.4 hold, the satisfactory error rate characteristics are obtained by appropriately adjusting the wobble amount depending on the composition of the recording layer. In particular, the following fact has been revealed. That is, in the case of the optical disk in which the wobble amount is 3%, the satisfactory error rate characteristics are obtained irrelevant to the composition when the recording layer is within the composition range of ((GeTe)ₓ(Bi₂Te₃)₁₋ₓ)_{1-y}Ge_{y} (provided that 0.3≦x<1 and 0<y≦0.4 hold).

### Second Embodiment

In a second embodiment, various optical disks were manufactured to evaluate the qualities of the address signal and the data signal in the same manner as in the first embodiment except that the information-recording and reproducing apparatus, which was used to measure the error rate, was changed.

Information-Recording and Reproducing Apparatus

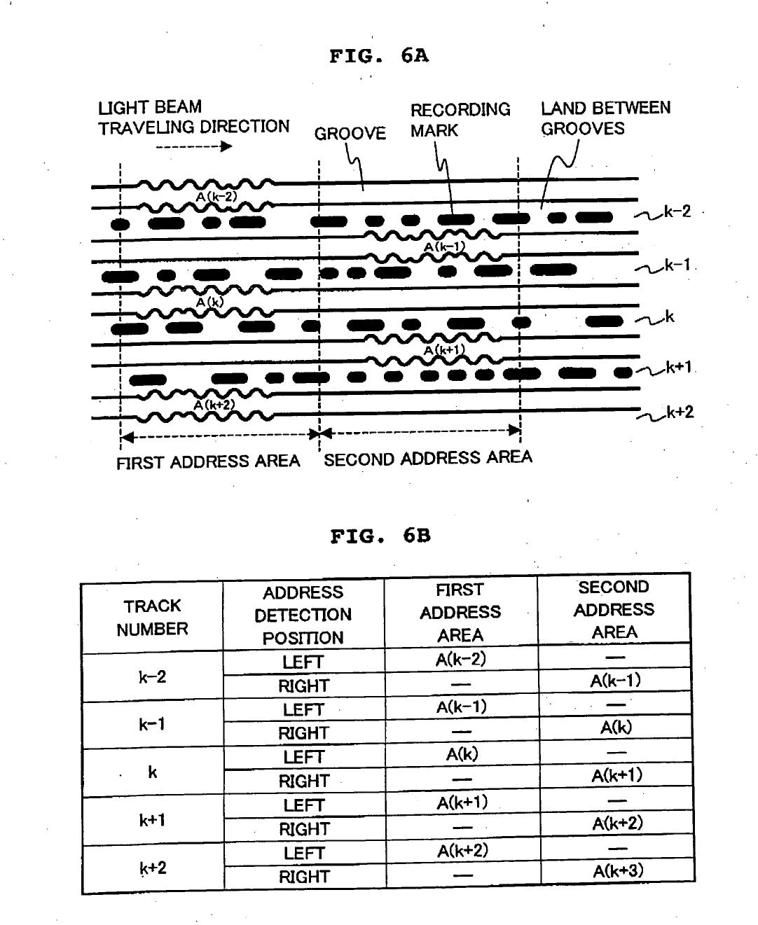

FIG. 5 shows a schematic arrangement of an information-recording and reproducing apparatus for recording and reproducing information on the optical disk manufactured in this embodiment. As shown in FIG. 5, the information-recording and reproducing apparatus 200 used in this embodiment principally includes a motor 11 which rotates the optical disk 21, an optical head 12 which radiates the laser beam onto the optical disk 21, an L/G servo circuit 13 which performs the tracking control, a reproduced signal-processing system 24, and a recording signal-processing system 17. As clarified from FIG. 5, the information-recording and reproducing apparatus 200 shown in FIG. 5 is constructed in the same manner as the information-recording and reproducing apparatus 100 shown in FIG. 4 except for the portion for constructing the reproduced signal-processing system 24. Therefore, an explanation will now be made about only the construction of the reproduced signal-processing system 24.

As shown in FIG. 5, the reproduced signal-processing system 24 includes a preamplifier circuit 15 which adjusts the gain of the reproduced signal, a 1-7 demodulator 16 which reproduces the information on the basis of the reproduced signal, and an address information-managing unit 25 which manages the address information. As shown in FIG. 5, the address information-managing unit 25 includes an address demodulator 26 which demodulates the reproduced address information, an address information right/wrong judging unit 27 which judges whether or not the desired address information is reproduced, and an address information-reconstructing unit 28 which reproduces the desired address information from the address information of the adjoining track. The preamplifier circuit 15 and the 1-7 demodulator 16 shown in FIG. 5 are the same devices as those of the preamplifier circuit and the 1-7 demodulator of the information-recording and reproducing apparatus shown in FIG. 4.

Next, an explanation will be made about the operation for reproducing the address information in the information-recording and reproducing apparatus used in this embodiment. The data information was reproduced in the same manner as in the first embodiment.

At first, the optical disk, which has the address area as shown in FIG. 2, is installed to the information-recording and reproducing apparatus 200 shown in FIG. 5, and the light beam is radiated onto the desired track (groove in the case of the optical disk shown in FIG. 2). Subsequently, the reproduced signal concerning the address information, which is obtained by the optical head 12, is subjected to the gain adjustment by the preamplifier circuit 15, and the signal is inputted into the address demodulator 26. Subsequently, the address information is reproduced from the reproduced signal by the address demodulator 26. The signal is transferred to the address information right/wrong judging unit 27. It is judged by the address information right/wrong judging unit 27 whether or not the address information of the desired track is reproduced. If the address information of the desired track is reproduced, the reproduced address information is outputted to the reproduced signal-processing system (not shown).

If the address information of the desired track is not reproduced, the judgment, which means this fact, is sent to the L/G servo circuit 13 from the address information right/wrong judging unit 27 to move the light beam to the adjoining track (groove in the case of the optical disk shown in FIG. 2). Subsequently, the light beam is radiated again onto the track adjoining the desired track to reproduce the address information of the adjoining track. The reproduced signal of the address information of the adjoining track, which is detected by the optical head 12, is sent to the address information-reconstructing unit 28 via the preamplifier circuit 15 and the address demodulator 26. The address information-reconstructing unit 28 specifies the address information of the desired track from the address information of the adjoining track, and the address information of the desired track is outputted.

The error rate of the address information was measured in the same manner as in the first embodiment by using the method for reproducing the address information as described above. As a result, the error rate was successfully reduced irrelevant to the number of times of the recording of the data information. Specifically, the evaluation “++” was successfully obtained for the optical disks which had the evaluation “+” in relation to the address error rate in Tables 1 to 13. However, the address information was unsuccessfully reconstructed for the optical disks which had the evaluation “−” of the address error rate in the first embodiment, because the error rate of the address information of the adjoining track was also increased.

### Third Embodiment

In a third embodiment, various optical disks were manufactured in the same manner as in the first embodiment except that the recording format was changed for the address information and the data information on the optical disk. The error rate was measured by using the information-recording and reproducing apparatus shown in FIG. 5 in the same manner as in the second embodiment to evaluate the qualities of the address information and the data information.

optical Disk

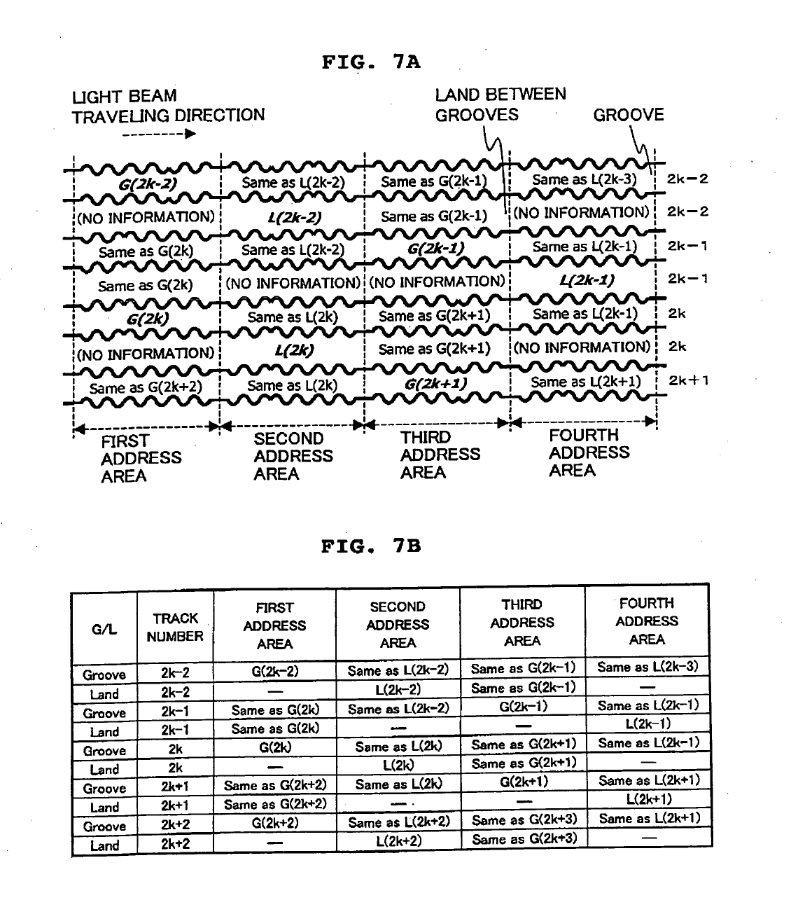

FIG. 6 schematically shows the recording format of the address information and the data information of the optical disk manufactured in this embodiment. In the case of the optical disk shown in FIG. 6, the data information (recording mark) is recorded on the land, and the address information of the track is formed by wobbling the groove in the radial direction. In the case of the optical disk shown in FIG. 6, one track was constructed by one set of the groove and the land which were adjacent to one another, and the groove and the land were designated by the same track number. That is, in the case of the optical disk shown in FIG. 6, the address information, which is formed in the groove, is the address information of the track including the groove. In the optical disk manufactured in this embodiment, the track pitch was 0.4 μm, and the wobble cycle was 93 channel bit.

In the case of the optical disk manufactured in this embodiment, as shown in FIG. 6, the pieces of the address information, which are recorded on the adjoining tracks, are arranged and deviated from each other so that they are not aligned in the radial direction. Specifically, the address information A(k) of the kth track shown in FIG. 6 is recorded in the first address area, and the pieces of address information A(k−1) and A(k+1) of the (k−1)th track and the (k+1)th track adjoining the kth track are formed in the second address area.

Reproduction Principle

The operation for reproducing the address information is performed as follows on the optical disk shown in FIG. 6. For example, when the kth land is scanned across the light beam in the direction of the broken line arrow shown in FIG. 6, the address information A(k) of the kth track from the left side with respect to the traveling direction of the light beam is firstly detected, and then the address information A(k+1) of the (k+1)th track from the right side with respect to the traveling direction of the light beam is detected (see FIG. 6B). Therefore, even when one address information was failed to be reproduced, the address information of the desired track can be specified from the other reproduced address information and the information on the reproduced side (left side or right side). For example, when the kth land is scanned across the light beam, even if the address information A(k) cannot be reproduced from the left side with respect to the traveling direction of the light beam, it is known that the address information of the land subjected to the scanning with the light beam is A(k) on condition that the address information A(k+1) of the (k+1)th track from the right side with respect to the traveling direction of the light beam is obtained. The step of reproducing the address information from the signals (see FIG. 6B) obtained from the left side and the right side with respect to the traveling direction of the light beam was performed by using the address information right/wrong judging unit 27 shown in FIG. 5.

As described above, in the case of the optical disk on which the address information is recorded in accordance with the format as shown in FIG. 6, the address information of the desired land can be reproduced without moving the light beam to the adjoining land or the adjoining groove, even when the address information of the desired land cannot be reproduced. Therefore, it is possible to reproduce the address information more easily. Therefore, in the case of the optical disk on which the address information and the data information are recorded in accordance with the format as shown in FIG. 6, the reliability of the address information is enhanced, and the reliability of the address information is not lowered even when the track pitch is decreased in order to realize the large capacity.

The optical disks manufactured in this embodiment were installed to the information-recording and reproducing apparatus shown in FIG. 5 to measure the error rate of the address information in the same manner as in the second embodiment. As a result, the error rate was successfully reduced irrelevant to the number of times of the recording of the data information. Specifically, the evaluation “++” was successfully obtained for the optical disks which had the evaluation “+” in relation to the address error rate an Tables 1 to 13. However, the address information was unsuccessfully reconstructed for the optical disks which had the evaluation “−” of the address error rate in the first embodiment, because the error rate of the address information of the adjoining track was also increased.

### Fourth Embodiment

In a fourth embodiment, various optical disks were manufactured in the same manner as in the first embodiment except that the recording format was changed for the address information and the data information on the optical disk. The error rate was measured by using the information-recording and reproducing apparatus shown in FIG. 5 in the same manner as in the second embodiment to evaluate the qualities of the address information and the data information.

Optical Disk

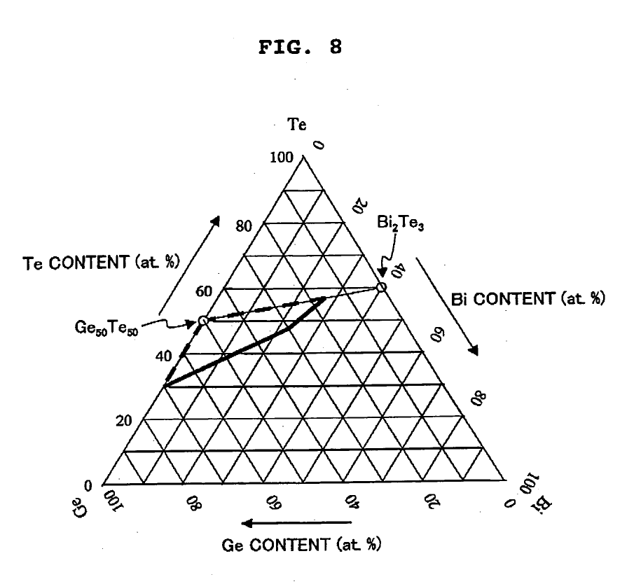

FIG. 7 shows a schematic structure of the header section of the optical disk manufactured in this embodiment. However, the format of the address information of the optical disk of the present invention is not limited to the example shown in FIG. 7, which may be appropriately designed in accordance with, for example, the specification of the optical disk. In the case of the optical disk shown in FIG. 7, the address information is recorded on the groove and the land. As shown in FIG. 7, the address information of each of the groove and the land is formed by wobbling the groove and the land in the radial direction respectively. In the case of the optical disk manufactured in this embodiment, the track pitch was 0.34 μm and the wobble cycle was 93 channel bit. In this embodiment, the data was recorded on the groove and the land (land-groove recording) (not shown).

AS shown in FIG. 7, the header section of each of the groove and the land is constructed by four areas from the first address area to the fourth address area. The header sections of the grooves and the lands are arranged and aligned in the radial direction of the optical disk respectively. As shown in FIG. 7, the pieces of address information are formed so that they are not aligned in the radial direction between the groove and the land which are adjacent to one another. Specifically, as shown in FIG. 7, the pieces of address information of the 2kth and the (2k−2)th grooves are recorded in the first address area shown in FIG. 7, the pieces of address information of the 2kth and (2k−2)th lands are recorded in the second address area, the pieces of address information of the (2k+1)th and (2k−1)th grooves are recorded in the third address area, and the pieces of address information of the (2k+1)th and (2k−1)th grooves are recorded in the fourth address area. In the case of the optical disk shown in FIG. 7, one track was constructed by one set of the groove and the land which were adjacent to one another, and the groove and the land were designated by the same track number in the same manner as in the optical disks manufactured in the first and third embodiments. However, as shown in FIG. 7, in the case of the optical disk manufactured in this embodiment, the pieces of address information are individually recorded on the grooves and the lands respectively.

As shown in FIG. 7, in the case of the optical disk manufactured in this embodiment, the pieces of address information of the groove and the land adjoining the predetermined groove and the land are recorded on the header sections of the predetermined groove and the land. The recording is made in the area which is different from the address area in which the pieces of address information of the predetermined groove and the land are recorded. For example, as for the 2kth groove shown in FIG. 7, the address information G(2k) of the 2kth groove is recorded in the first address area, the address information L(2k) of the 2kth land, the address information G(2k+1) of the (2k+1)th groove, and the address information L(2k−1) of the (2k−1)th land are recorded in the second, third, and fourth address areas respectively. As for the 2kth land shown in FIG. 7, the address information L(2k) of the 2kth land is recorded in the second address area, and the address information G(2k+1) of the (2k+1)th groove is recorded in the third address area. In the case of the exemplary optical disk shown in FIG. 7, for example, the first address area on the 2kth land shown in FIG. 7 is the boundary portion between the address information G(2k) of the 2kth groove and the address information G(2k+2) of the (2k+2)th groove as shown in FIG. 7. Therefore, the address information is absent therein. Similarly, the fourth address area on the 2kth land shown in FIG. 7 is also the boundary portion between the address information L(2k−1) of the (2k−1)th land and the address information L(2k+1) of the (2k+1)th land as shown in FIG. 7. Therefore, the address information is absent therein.

Reproduction Principle

The operation for reproducing the address information is reproduced as follows on the optical disk on which the address information is recorded in accordance with the format as shown in FIG. 7. However, the method for reproducing the address information of the present invention is not limited to the following method, which may be appropriately changed depending on the recording format of the address information.

For example, when the 2kth groove shown in FIG. 7 is scanned across the light beam in the broken line direction shown in FIG. 7, the pieces of address information are detected in the order of the address information G(2k) of the 2kth groove, the address information L(2k) of the 2kth land, the address information G(2k+1) of the (2k+1)th groove, and the address information L(2k−1) of the (2k−1)th land. Therefore, even if the address information G(2k) of the 2kth groove, which is recorded in the first address area, cannot be reproduced when the 2kth groove is scanned across the light beam, the address information G(2k) of the 2kth groove can be specified from the detected address information and the information on the detection sequence or the like, on condition that the pieces of address information of the land and the groove adjoining the 2kth groove recorded in the other address areas can be detected. In particular, if the information (position information) concerning the areas in which the respective pieces of address information are recorded is included in the address information, it is easier to specify the address information of the predetermined groove or the land.

An explanation will be made specifically below about the method for specifying the address information of the desired groove or the land from the address information detected when the light beam is radiated onto the desired groove or the land to reproduce the address information on the optical disk shown in FIG. 7.

When the address information is reproduced by radiating the light beam onto the desired land, if two pieces of address information can be reproduced, then the address information itself of the desired land is detected as clarified from FIG. 7B. The address information concerning the land, which is included in the detected two pieces of address information, is the address information of the desired land.

When the address information is reproduced by radiating the light beam onto the desired land, if only one address information can be reproduced, then the information is the address information of the desired land, if the reproduced address information is the address information of the land. If the reproduced address information is the address information of the groove, the address information is the address information of the groove of the track (track having the track number smaller by 1 than the track number of the desired land in the example shown in FIG. 7) adjoining the desired land. Therefore, if the entire address arrangement is previously determined, the address information of the desired land can be specified from the address information of the groove of the track adjoining the desired land.

When the address information is reproduced by radiating the light beam onto the desired groove, if four pieces of address information can be reproduced, then the address information of the desired groove is included in the four pieces of address information. In this case, the address information of the desired groove is specified from the detected address information and the information on the detection sequence or the like.

When the address information is reproduced by radiating the light beam onto the desired groove, if continuous three pieces of address information can be reproduced, then the following three method are conceived in order to specify the address information of the desired groove in accordance with the detection pattern of the address information.

The first detection pattern resides in such a case that the address information, which can be firstly reproduced, is the address information of the land, and the track number of the groove subjected to the scanning across the light beam is even. In this case, the address information of the desired groove is not included in the detected three pieces of address information. That is, the address information of the desired groove was failed to be reproduced. Therefore, in this case, the three pieces of address information, which are continuously reproduced, are the pieces of address information of the land and the groove adjoining the desired groove. Therefore, the address information of the desired groove is specified from the three pieces of address information and the information on the detection sequence or the like.

The second detection pattern resides in such a case that the address information, which can be firstly reproduced, is the address information of the land, and the track number of the groove subjected to the scanning across the light beam is odd. In this case, the address information of the desired groove is included in the reproduced three pieces of address information. The address information, which is detected secondly, is the address information of the desired groove.

The third detection pattern resides in such a case that the address information, which can be firstly reproduced, is the address information of the groove. In this case, if the track number of the groove subjected to the scanning across the light beam is even, the address information, which is firstly detected, is the address information of the desired groove. If the track number of the groove subjected to the scanning across the light beam is odd, the address information, which is thirdly detected, is the address information of the desired groove.

Next, when the address information is reproduced by radiating the light beam onto the desired groove, if discontinuous three pieces of address information can be reproduced, then the address information, which is firstly detected, is the address information of the desired groove, if the track number of the groove subjected to the scanning across the light beam is even. If the track number of the groove subjected to the scanning across the light beam is odd, and the pieces of address information of the two grooves are included in the successfully reproduced pieces of address information, then the address information of the groove, which is secondly detected, is the address information of the desired groove. If the track number of the groove subjected to the scanning across the light beam is odd, and only one piece of address information of the groove is included in the reproduced address information, then the address information of the desired groove was failed to be reproduced. In this case, the address information of the desired groove is specified from the reproduced three pieces of address information and the information on the detection sequence or the like. If the arrangement of the entire address information is previously determined, it is possible to specify the address information of the desired groove.

When the address information is reproduced by radiating the light beam onto the desired groove, if continuous two pieces of address information can be detected, then the following three methods are conceived in order to specify the address information of the desired groove from the detection pattern of the address information.

In the case of the first detection pattern, if the successfully reproduced pieces of address information are in an order of those of the groove and the land, and the track information (track number) is identical between the both, then the reproduced address information of the groove is the address information of the desired groove.

In the case of the second detection pattern, if the successfully reproduced pieces of address information are in an order of those of the groove and the land, and the track information (track number) is different between the both, then the address information of the desired groove was failed to be reproduced. In this case, the reproduced address information of the groove is the address information of the groove disposed adjacently by one track with the land intervening therebetween, the intervening land having the same track number as that of the desired groove. Therefore, the address information of the desired groove can be specified on the basis of the address information of the adjoining groove. The reproduced address information of the land is the address information of the land disposed on the side on which the track information (track number) differs, of the lands adjoining on the both adjacent sides of the desired groove. Therefore, the address information of the desired groove may be specified from the address information of the adjoining land.

In the case of the third detection pattern, if the reproduced pieces of address information are in an order of those of the land and the groove, it is impossible to judge whether the reproduction of the address information of the desired groove is successful or unsuccessful. In this case, the light beam is moved to the land (land having the same track number in the example shown in FIG. 7) adjoining in the direction to increase the track number so that the address information of the adjoining land is reproduced to make the judgment. In this procedure, if the address information exists in the same address area as that of the two pieces of address information continuously detected by firstly radiating the light beam onto the desired groove, the address information of the desired groove is not included in the two pieces of address information continuously detected by firstly radiating the light beam onto the desired groove. In this case, the address information of the desired groove is specified from the two pieces of address information continuously detected by firstly radiating the light beam onto the desired groove. On the other hand, when the light beam is moved to the adjoining land to reproduce the address information of the adjoining land, if the address information does not exist in the same address area as that of the two pieces of address information continuously detected by firstly radiating the light beam onto the desired groove, then the address information of the desired groove is included in the continuously detected two pieces of address information. The address information, which is detected secondly, is the address information of the desired groove.

When the address information is reproduced by radiating the light beam onto the desired groove, if discontinuous two pieces of address information can be detected, then the following three methods are conceived in order to specify the address information of the desired groove from the address information.

The first detection pattern resides in such a case that the pieces of address information are detected in an order of those of the land and the land. In this case, the address information of the desired groove was failed to be reproduced. However, if the track number of the address information of the firstly detected land is larger than the track number of the address information of the secondly detected land, the track number of the desired groove is the same as the track number of the firstly detected land on the contrary, if the track number of the address information of the firstly detected land is smaller than the track number of the address information of the secondly detected land, the track number of the desired groove is the same as the track number of the secondly detected land. Therefore, if the detected pieces of address information are those in the order of the land and the land, the address information of the desired groove can be specified from the relationship of largeness/smallness between the track number of the address information of the firstly detected land and the track number of the address information of the secondly detected land.

The second detection pattern resides in such a case that the pieces of address information are detected in an order of the groove and the groove. In this case, it cannot be judged whether the information of the desired groove is reproduced successfully or unsuccessfully, from only the pieces of information. In this case, the light beam is moved from the desired groove to the land (land having the same track number in the example shown in FIG. 7) adjoining in the direction to increase the track number so that the address information of the adjoining land is reproduced to make the judgment. When the address information of the adjoining land is reproduced, if the address information exists in the same address area as that of the secondly detected address information of the two pieces of address information firstly detected from the desired groove, then the first address information, which is included in the two pieces of address information firstly detected from the desired groove, is the address information of the desired groove. On the contrary, when the address information of the adjoining land is reproduced, if the address information exists in the same address area as that of the first address information of the two pieces of address information firstly detected from the desired groove, then the second address information, which is included in the two pieces of address information firstly detected from the desired groove, is the address information of the desired groove.

The third detection pattern resides in such a case that the pieces of address information are detected in an order of the groove and the land. Also in this case, it cannot be judged whether the address information of the desired groove is reproduced successfully or unsuccessfully, from only the pieces of address information. In this case, the light beam is moved from the desired groove to the land adjoining in the direction to increase the track number so that the address information of the adjoining land is reproduced to make the judgment. When the address information of the adjoining land is reproduced, if the address information does not exist in the same address area as that of the two pieces of address information firstly detected from the desired groove, then the first address information, which is included in the two pieces of address information detected from the desired groove, is the address information of the desired groove. On the contrary, when the address information of the adjoining land is reproduced, if the address information exists in the same address area as that of the two pieces of address information firstly detected from the desired groove, then it is known that the address number of the first address information included in the two pieces of address information firstly detected from the desired groove is the track number which is smaller by 1 than the track number of the desired groove. Therefore, the address information of the desired groove is specified from this information.

When the address information is reproduced by radiating the light beam onto the desired groove, if only one piece of address information can be reproduced, then it is difficult to judge whether the address information of the desired groove is reproduced successfully or unsuccessfully, with only the address information. Therefore, the address information of the adjoining land is reproduced. The address information of the desired groove is specified from the address information obtained from the adjoining land and the one piece of address information detected for the desired groove. If the address information includes the information concerning the address storage position (first to fourth address areas shown in FIG. 7), the detected address information and the information on the storage position can be used to judge whether the address information of the desired groove is reproduced successfully or unsuccessfully and specify the address information of the desired groove.

The address information right/wrong judging unit 27, which is included in the information-recording and reproducing apparatus shown in FIG. 5, is used to judge whether the pieces of address information of the desired groove and the desired land are reproduced successfully or unsuccessfully and specify the pieces of address information of the desired, groove and the desired land. However, when the address information of the desired groove is specified, if the address information of the desired groove is specified from the address information obtained from the adjoining land by radiating the light beam onto the adjoining land, then the address information of the desired groove is specified by using the address-reconstructing unit 28.

As described above, in the case of the optical disk on which the address information is recorded in accordance with the format as shown in FIG. 7, the address information of the desired groove or the land can be specified from the address information of the adjoining land and the groove, even if the address information of the desired groove or the land cannot be reproduced. Therefore, it is possible to much more reliably reproduce the address information of the desired groove or the land. Further, as shown in FIG. 7, the address information of the groove and the land adjacent to the desired groove is recorded on the header section of the desired groove. Therefore, the address information of the desired groove can be specified without moving the light beam to the adjoining land, depending on the detection pattern of the address information detected by radiating the light beam onto the desired groove. Therefore, it is possible to obtain the address information more easily and quickly.

The error rate of the address information was measured in the same manner as in the second embodiment by installing the optical disks manufactured in this embodiment to the information-recording and reproducing apparatus shown in FIG. 5. As a result, the error rate was successfully reduced irrelevant to the number of times of the recording of the data information. Specifically, the evaluation “++” was successfully obtained in relation to the optical disks which had the evaluation “+” for the address error rate in Tables 1 to 13. However, the address information was unsuccessfully reconstructed in relation to the optical disks which had the evaluation “−” of the address error rate in the first embodiment, because the error rate of the address information of the adjoining track was also increased.

Preferred Range of Track Pitch

In the first, third, and fourth embodiments described above, the substrate was used, in which the groove having the track pitch of 0.34 μm or 0.4 μm was formed. However, the present invention is not limited thereto. Various optical disks, in which the track pitch was changed within a range of 0.218 μm to 0.436 μm, were manufactured to measure the error rate characteristics in the same manner as in the first, third, and fourth embodiments. As a result, the same or equivalent results as those obtained in the first, third, and fourth embodiments were obtained. However, as for the optical disk in which the track pitch was larger than 0-436 μm, the satisfactory characteristics were obtained even in the case of the use of a composition film without the preferred composition range of recording layer described in the embodiments of the present invention. That is, this result indicates the following fact. When the track pitch is wide and the recording density is relatively small, then the satisfactory characteristics can be obtained even in the case of the recording layer within the composition range of the conventional technique. However, when the track pitch is narrowed and the recording density is increased, then the recording layer within the composition range of the present invention is extremely effective. When the track pitch was smaller than 0.218 μm, for example, problems arose such that the tracking was not only unstable, but the crosstalk and the cross-erase conspicuously appeared.

Preferred Thickness Range of Respective Constitutive Layers

Various optical disks, in which the thicknesses of the respective layers for constructing the optical disks of the first, third, and fourth embodiments described above were variously changed, were manufactured to measure the error rate for the address information and the data information in the same manner as in the first, third, and fourth embodiments.

When the protective layer was changed within a range of 40 nm to 80 nm in the optical disk according to the first, third, and fourth embodiments, the satisfactory error rate characteristics, which were equivalent to those obtained in the first, third, and fourth embodiments, were obtained. If the thickness of the protective layer is smaller than 40 nm, or if the thickness of the protective layer is larger than 80 nm, then any one of problems of the decrease in the reflectance and the decrease in the signal modulation degree was caused, and the error rate of the data information was increased.

When the thickness was thickened by a thickness of N·λ/(2n) (n herein represents the refractive index of the protective layer, λ represents the wavelength of the light beam to be used for the recording and reproduction, and N represents a natural number) on the basis of the thickness range (40 nm to 80 nm) of the protective layer described above, the equivalent satisfactory error rate characteristics were also obtained. For example, in the case of n=2.3, λ=405 nm, and N=1, the additional thickness is 90 nm, and the thickness range of the entire protective layer is 130 nm to 170 nm. However, in this case, a problem arises in relation to the productivity, because the thickness of the protective layer is thickened.

Subsequently, the thickness of the recording layer was changed within a range of 5 nm to 25 nm in the optical disk according to the first, third, and fourth embodiments to measure the error rate in the same manner as described above. As a result, the satisfactory error rate characteristics, which were equivalent to those obtained as described above, were obtained. If the thickness of the recording layer is thinner than 5 nm, then the reflectance was decreased, the signal modulation degree was decreased, and the error rate of the data information was increased. On the other hand, if the thickness of the recording layer was thicker than 25 nm, the error rate of the data information was increased even in the rewriting of the data information performed not more than 1,000 times. Further, if the thickness of the recording layer is thicker than 25 nm, then the recrystallization width is increased around the recording mark, and the quality of the address signal was deteriorated as well.

The thickness of the intermediate layer was changed within a range of 30 nm to 60 nm in the optical disk according to the first, third, and fourth embodiments to measure the error rate in the same manner as described above. As a result, the satisfactory error rate characteristics, which were equivalent to those obtained as described above, were obtained. If the thickness of the intermediate layer was smaller than 30 nm, the distance between the heat-diffusing layer and the recording layer was shortened. Therefore, the so-called cross-erase tended to occur such that the heat, which was brought about by the light beam radiated onto the recording layer during the information recording, was spread in the in-plane direction via the heat-diffusing layer to erase the information on the adjoining track. The error rate of the data information was increased. If the intermediate layer was larger than 60 nm, then the reflectance was lowered, and the error rate was increased. As for the thickness of the intermediate layer, it is necessary that the thickness is to some extent in order to reduce the cross-erase. In particular, when the thickness of the intermediate layer was thicker than 36 nm which was 0.8 time the groove depth of the substrate of 45 nm, the effect to reduce the cross-erase was further enhanced.

The thickness of the heat-diffusing layer was changed within a range of 30 nm to 300 nm in the optical disk according to the first, third, and fourth embodiments to measure the error rate in the same manner as described above. As a result, the satisfactory error rate characteristics, which were equivalent to those obtained as described above, were obtained. If the heat-diffusing layer is thinner than 30 nm, then it is difficult to quickly cool the recording layer when the recording mark is formed, and the recrystallization area is increased. For this reason, the error rate of the data information was not only increased, but the influence of the recrystallization area exerted on the wobble signal quality was also increased. The error rate of the address information was increased as well. If the thickness of the heat-diffusing layer was thicker than 300 n, the recording sensitivity was deteriorated.

Optimum Film Construction

The optimum compositions and the optimum thicknesses of the respective layers for constructing the optical disk of the present invention will be summarized and explained below.

Protective Layer

The substance, which exists on the light-incoming side of the protective layer, is a plastic substrate such as polycarbonate or an organic material such as ultraviolet-curable resin. The refractive index of the substance is about 1.4 to 1.65. In order to effectively cause the reflection between the organic material and the protective layer, it is desirable that the refractive index of the protective layer is not less than 2.0. In an optical viewpoint, it is appropriate that the refractive index of the protective layer has a value which is not less than that of the refractive index of the substance existing on the light-incoming side (corresponding to the substrate in this embodiment), and it is preferable that the refractive index of the protective layer is larger within a range in which no light absorption occurs. Specifically, the refractive index n of the protective layer preferably has a value between 2.0 to 3.0. It is desirable that the protective layer is formed of a material which does not absorb the light, and the protective layer especially contains, for example, oxide, nitride, carbide, sulfide, and/or selenide of metal.

It is desirable that the coefficient of thermal conductivity of the protective layer is not more than at least 2 W/mk. In particular, the compound based on ZnS—SiO₂ has a low coefficient of thermal conductivity, which is optimum for the protective layer. Further, SnO₂ or the material obtained by adding sulfide such as ZnS, CdS, SnS, GeS, and PbS to SnO₂, or the material obtained by adding transition metal oxide such as Cr₂O₃, and Mo₃O₄ to SnO₂ not only has a low coefficient of thermal conductivity, but the material is also thermally stable as compared with the material based on ZnS—SiO₂. Therefore, such a material especially exhibits the excellent characteristics as the protective layer, because the material is not melted and mixed into the recording layer even when the first thermostable layer, which is provided between the protective layer and the recording layer, has a thickness of not more than 2 nm.

In order to effectively utilize the optical interference between the substrate and the recording layer, the optimum thickness of the protective layer is 40 nm to 80 nm when the wavelength of the laser beam is about 405 nm.

First Thermostable Layer

The melting point of the phase-change material to be used for the recording layer of the optical disk of the present invention is not less than 650° C. which is a high temperature. Therefore, it is desirable that the first thermostable layer, which is extremely stable thermally, is provided between the protective layer and the recording layer. Specifically, it is desirable to use high melting point oxide, high melting point nitride, and high melting point carbide such as Cr₂O₃, Ge₃N₄, and SiC as the material for forming the first thermostable layer. The material as described above is thermally stable. Any deterioration, which would be otherwise caused by the film exfoliation, is not caused even after the storage for a long term. Another oxide such as SnO₂ and any sulfide such as ZnS may be added to the material as described above. When such a material is added, it is possible to adjust the optical constant. In particular, when such a material is added to a material having a large extinction coefficient, it is possible to decrease the extinction coefficient of the first thermostable layer, which is preferred. In particular, SnO₂ as the oxide is preferred.

When the material such as Bi, Sn, and Pb, which facilitates the crystallization of the recording layer, is contained in the first thermostable layer, it is possible to obtain the effect to suppress the recrystallization of the recording layer, which is more desirable. In particular, it is desirable to use Te compound or oxide of Bi, Sn, or Pb, mixture of Te compound or oxide of Bi, Sn, of Pb and germanium nitride, or mixture of Te compound or oxide of Bi, Sn, or Pb and transition metal oxide and/or transition metal nitride, for the following reason. That is, the valency number of the transition metal is changed with ease. Therefore, even when the element such as Bi, Sn, Pb, and Te is liberated, then the valency number of the transition metal is changed, the bonding is formed between the transition metal and the element such as Bi, Sn, Pb, and Te, and the thermally stable compound is produced. In particular, Cr, Mo, and W are excellent materials, because they have high melting points, they change the valency number with ease, and they easily produce the thermally stable compounds together with the element such as Bi, Sn, Pb, and Te.

It is desirable that the content of the Te compound or the oxide of Bi, Sn, or Pb in the first thermostable layer is as large as possible in order to facilitate the crystallization of the recording layer. However, the first thermostable layer tends to have a high temperature by being irradiated with the laser beam as compared with the second thermostable layer For example, a problem arises such that the thermostable layer material is melted and mixed into the recording film. Therefore, it is necessary that the content of at least the Te compound or the oxide of Bi, Sn, or Pb is suppressed to be not more than 70%.

When the thickness of the first thermostable layer is not less than 0.5 nm, the effect is exhibited. However, if the thickness of the first thermostable layer is thinner than 2 nm, then the material for forming the protective layer is melted and mixed into the recording layer via the first thermostable layer, and the reproduced signal quality after the rewriting performed many times is deteriorated in some cases. Therefore, it is desirable that the thickness of the first thermostable layer is not less than 2 nm. If the thickness of the first thermostable layer is thicker than 10 nm, any optically harmful influence is exerted. Therefore, for example, any inconvenience arises such that the reflectance is lowered, and the signal amplitude is decreased. Therefore, it is desirable that the thickness of the first thermostable layer is 2 nm to 10 nm.

Recording Layer

As described above, it is preferable that the composition of the phase-change material based on Bi—Ge—Te to be used for the recording layer satisfies ((GeTe)ₓ(Bi₂Te₃)₁₋ₓ)_{1-y}Ge_{y} (provided that 0.3≦x<1 and 0<y≦0.4 hold). The composition range is illustrated in the triangular composition diagram shown in FIG. 8. The composition range, which is in the area surrounded by the thick lines and the broken lines shown in FIG. 8, is the composition range which is most suitable for the recording layer of the optical disk of the present invention. However, the compositions located on the broken lines are not included. When the composition condition is satisfied, for example, if an appropriate amount of Si, Sn, or Pb is added in place of Ge, then it is possible to easily adjust the linear velocity range capable of being adapted. For example, when a part of Ge is substituted with Si, SiTe is produced, which has a smaller crystallization velocity and a higher melting point as compared with Ge and GeTe. Therefore, SiTe is segregated at the outer edge portion of the melted part, and the recrystallization of the outer edge portion of the melted part is suppressed. When GeTe is substituted with SnTe or PbTe, it is possible to supplement the insufficient erasing upon the high speed recording, because the velocity of the nucleus generation is improved.

That is, the phase-change materials, which are preferred for the recording layer, are as follows.
Four-element recording layer material: Bi—Ge—Si—Te, Bi—Ge—Sn—Te, Bi—Ge—Pb—Te;
Five-element recording layer material: Bi—Ge—Si—Sn—Te, Bi—Ge—Si—Pb—Te, Bi—Ge—Sn—Pb—Te;
Six-element recording layer material: Bi—Ge—Si—Sn—Pb—Te.
When the multi-element material as described above is used, it is possible to control the performance of the recording layer material more finely.

When B is added to the recording layer material to be used for the optical disk of the present invention, the recrystallization is further suppressed. Therefore, the optical disk, which exhibits the excellent performance, is obtained, for the following reason. That is, B has the effect to suppress the recrystallization in the same manner as Ge. Further, it is considered that B is segregated quickly, because the B atom is extremely small.

On condition that the recording layer material to be used for the optical disk of the present invention maintains the relationship within the range represented by the composition formula as described above, the effect of the present invention is not lost even when any impurity is mixed provided that the atomic % of the impurity is within 1%.

In the case of the medium structure of the present invention, it is optically preferable that the thickness of the recording layer is 5 nm to 25 nm. In particular, it is most optically suitable that the thickness of the recording layer is 5 nm to 15 nm.

Second Thermostable Layer

The melting point of the phase-change material to be used for the recording layer of the present invention is not less than 650° C. which is a high temperature. Therefore, it is desirable that the second thermostable layer, which is extremely stable thermally, is provided between the intermediate layer and the recording layer in the same manner as the first thermostable layer. Specifically, it is preferable to use high melting point oxide, high melting point nitride, and high melting point carbide such as Cr₂O₃, Ge₃N₄, and SiC. The material as described above is thermally stable. Any deterioration, which would be otherwise caused by the film exfoliation, is not caused even after the storage for a long term. Therefore, the material as described above is suitable as the material for the second thermostable layer.

When the material such as Bi, Sn, and Pb, which facilitates the crystallization of the recording layer, is contained in the second thermostable layer, it is possible to obtain the effect to suppress the recrystallization of the recording layer, which is more desirable. In particular, it is desirable to use Te compound or oxide of Bi, Sn, or Pb, mixture of Te compound or oxide of Bi, Sn, of Pb and germanium nitride, or mixture of Te compound or oxide of Bi, Sn, or Pb and transition metal oxide and/or transition metal nitride, for the following reason. That is, the valency number of the transition metal is changed with ease. Therefore, even when the element such as Bi, Sn, Pb, and Te is liberated, then the valency number of the transition metal is changed, the bonding is formed between the transition metal and the element such as Bi, Sn, Pb, and Te, and the thermally stable compound is produced. In particular, Cr, Mo, and W are excellent materials, because they have high melting points, they change the valency number with ease, and hence they easily produce the thermally stable compounds together with the element such as Bi, Sn, Pb, and Te.

It is desirable that the content of the Te compound or the oxide of Bi, Sn, or Pb in the second thermostable layer is as large as possible in order to facilitate the crystallization of the recording layer. However, in order to optimize the optical condition, it is necessary that the content of at least the Te compound or the oxide of Bi, Sn, or Pb is suppressed to be not more than 70%.

When the thickness of the second thermostable layer is not less than 0.5 nm, the effect is exhibited However, if the thickness of the second thermostable layer is thinner than 1 nm, then the material for forming the intermediate layer is melted and mixed into the recording layer via the second thermostable layer, and the reproduced signal quality after the rewriting performed many times is deteriorated in some cases. Therefore, it is desirable that the thickness of the second thermostable layer is not less than 1 nm. If the thickness of the second thermostable layer is thicker than 5 nm, any optically harmful influence is exerted. Therefore, for example, any inconvenience arises such that the reflectance is lowered, and the signal amplitude is decreased. Therefore, it is desirable that the thickness of the second thermostable layer is 1 nm to 5 mm.

Intermediate Layer

The intermediate layer to be used for the optical disk of the present invention is desirably composed of a material which does not absorb the light and which especially contains oxide, carbide, nitride, sulfide, or selenide of metal. Further, it is desirable that the coefficient of thermal conductivity is not more than at least 2 W/mk. In particular, the compound based on ZnS—SiO₂ has the low coefficient of thermal conductivity, which is most suitable as the material for forming the intermediate layer. It is preferable to use SiO₂, a material obtained by adding sulfide such as ZnS, CdS, SnS, GeS, and PbS to SiO₂, or a material obtained by adding transition metal oxide such as Cr₂O₃, and Mo₃O₄ to SiO₂. The material as described above has the low coefficient of thermal conductivity, and the material is thermally stable as compared with the material based on ZnS—SiO₂. Therefore, even when the thickness of the second thermostable layer is less than 1 nm or even when the second thermostable layer is not provided, then the material of the intermediate layer is not melted and mixed into the recording layer. Therefore, the material as described above exhibits the especially excellent characteristics as the material for forming the intermediate layer.

In order to effectively utilize the optical interference between the recording layer and the absorptance control layer as described later on, the optimum thickness of the intermediate layer is 25 nm to 60 nm when the wavelength of the laser beam is about 405 mm. However, if the following relationship especially holds among the track pitch TP, the wavelength λ of the laser beam, and the numerical aperture NA of the light-collecting lens when the track pitch is narrow:
0.35×(λ/NA)≦TP≦0.7×(λ/NA)
it is preferable that the thickness of the intermediate layer is not less than 30 nm in order to avoid the cross-erase from the adjoining track. Further, it is preferable that the thickness of the intermediate layer is not less than 0.8 time the groove depth. In this case, when a material having a refractive index of not more than 1.7, for example, a material such as SiO, and Al₁O₃ was contained by at least not less than 25% in the material for forming the intermediate layer, the sufficient reflectance was successfully secured even when the thickness of the intermediate layer had a value larger than 0.8 time the groove depth. Thus, the optical optimization was successfully made so that the large contrast is obtained between the crystal and the amorphous.
Absorptance Control Layer

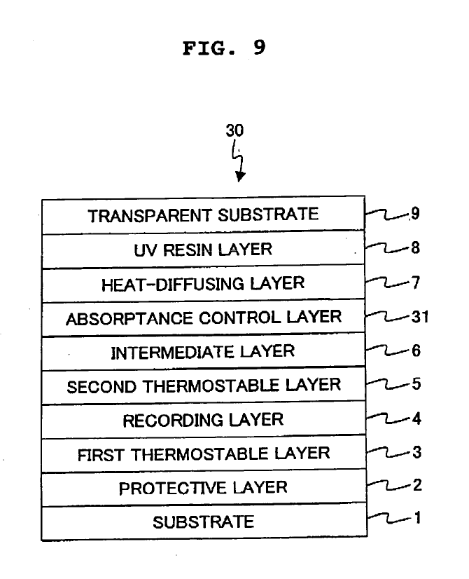

In the case of the optical disk of the present invention, the absorptance control layer may be provided between the intermediate layer and the heat-diffusing layer. FIG. 9 shows a schematic sectional view illustrating an optical disk obtained when the absorptance control layer is added. It is preferable that the complex refractive indexes n and k of the absorptance control layer are within ranges of 1.4<n<4.5 and −3.5<k<−0.5 respectively. In particular, it is desirable to use a material in which the complex refractive indexes n and k are within ranges of 2<n<4 and −3.0<k<−0.5. The absorptance control layer absorbs the light. Therefore, it is preferable to use a material which is thermally stable. Desirably, it is required that the melting point is not less than 1,000° C.

When sulfide was added to the protective layer, the especially great effect was obtained to reduce the cross-erase. However, in the case of the absorptance control layer, it is desirable that the content of sulfide such as ZnS is smaller than at least the content of sulfide to be added to the protective layer, for the following reason. That is, when the content of sulfide in the absorptance control layer is larger than the content of sulfide to be added to the protective layer, any harmful influence including, for example, the decrease in melting point, the decrease in coefficient of thermal conductivity, and the decrease in absorptance appears in some cases.

It is desirable to use a mixture of metal and metal oxide, metal sulfide, metal nitride, or metal carbide as the material for the absorptance control layer. A mixture of Cr and Cr₂O₃ exhibited an especially satisfactory effect to improve the overwrite characteristics. In particular, when Cr is 60 to 95 atomic %, it is possible to obtain the material having the coefficient of thermal conductivity and the optical constant suitable for the present invention. Specifically, those desirably usable as the metal include, for example, Al, Cu, Ag, Au, Pt, Pd, Co, Ti, Cr, Ni, Mg, Si, V, Ca, Fe, Zn, Zr, Nb, Mo, Rh, Sn, Sb, Te, Ta, W, Ir, Pb, and mixture. Those preferably usable as the metal oxide, the metal sulfide, the metal nitride, and the metal carbide include, for example, SiO₂, SiO, TiO₂, Al₂O₃, Y₂O₃, Ceo, La₂O₃, In₂O₃, GeO, GeO₂, PbO, SnO, Sno₂, Bi₂O₃, TeO₂, MO₂, WO₂, WO₃, Sc₂O₃, Ta₂O₅ and ZrO₂. Other than the above, it is also allowable to use, as the absorptance control layer, oxides including, for example, Si—O—N-based materials, Si—Al—O—N-based materials, Cr—O-based materials such as Cr₂O₃, and Co—O-based materials such as CO₂O₃ and CoO; nitrides including, for example, TaN, AlN, Si—N-based materials such as Si₃N₄, Al—Si—N-based materials (for example, AlSiN₂), and Ge—N-based materials; sulfides including for example, ZnS, Sb₂S₃, CdS, In₂S₃, Ga₂S₃, GeS, SnS₂, PbS, and Bi₂S₃; selenides including, for example, SnSe₃, Sb₂Se₃, CdSe, ZnSe, In₂Se₃, Ga₂Se₃, GeSe, GeSe₂, SnSe, PbSe, and Bi₂Se₃; fluorides including, for example, CeF₃, MgF₂, and CaF₂; and materials having compositions close to those of the materials as described above.

It is desirable that the thickness of the absorptance control layer is 10 nm to 100 nm. In particular, the effect to improve the overwrite characteristics, which is more satisfactory, is expressed within a thickness range of 20 nm to 50 nm. When the sum of the thicknesses of the protective layer and the absorptance control layer is not less than the groove depth, the effect to reduce the cross-erase is remarkably expressed.

As described above, the absorptance control layer has the property to absorb the light. Therefore, the absorptance control layer also absorbs the light to generate the heat in the same manner as the recording layer which absorbs the light to generate the heat. It is important that the light absorptance of the absorptance control layer is larger when the recording layer is in the amorphous state than when the recording layer is in the crystalline state. When the absorptance control layer is optically designed as described above, the effect appears such that the absorptance Aa, which is obtained in the recording layer when the recording layer is in the amorphous state, is smaller than the absorptance Ac which is obtained in the recording layer when the recording layer is in the crystalline state. Owing to this effect, it is possible to greatly improve the overwrite characteristics. In order to obtain this effect, it is necessary that the absorptance in the absorptance control layer is raised to about 30 to 40%.

The amount of heat generation in the absorptance control layer differs depending on the fact that the state of the recording layer is the crystalline state or the amorphous state. Therefore, the flow of heat from the recording layer to the heat-diffusing layer is changed depending on the state of the recording layer. Therefore, this phenomenon can be utilized to suppress the increase in jitter which would be otherwise caused by the overwrite. This effect is caused such that the temperature of the absorptance control layer is raised, and thus the flow of heat from the recording layer to the heat-diffusing layer is effectively cut off. In order to effectively utilize this effect, it is preferable that the sum of the thicknesses of the protective layer and the absorptance control layer is not less than the difference in height between the land and the groove, i.e., the groove depth on the substrate (about 1/7 to 1/5 of the laser beam wavelength). If the sum of the thicknesses of the protective layer and the absorptance control layer is smaller than the difference in height between the land and the groove, then the heat, which is generated when the recording is performed in the recording layer, is transmitted via the heat-diffusing layer, and the recording mark, which is recorded on the adjoining track, tends to be erased.

Heat-Diffusing Layer

Metal or alloy, which has a high reflectance and a high coefficient of thermal conductivity, is preferably usable for the heat-diffusing layer to be used for the optical disk of the present invention. It is desirable that the total content of Al, Cu, Ag, Au, Pt, Pd and the like is not less than 90 atomic %. A material such as Cr, Mo, and W having a high melting point and a large hardness and an alloy composed of such a material are also preferred, because it is possible to avoid the deterioration which would be otherwise caused by the flow of the recording layer material upon the rewriting performed many times. In particular, when the heat-diffusing layer is formed of a material containing Al by not less than 95 atomic %, it is possible to obtain the optical disk which is cheap, which makes it possible to obtain high CNR and high recording sensitivity, which is excellent in durability against the rewriting performed many times, and which has an extremely large effect to reduce the cross-erase. In particular, when the heat-diffusing layer is formed of a material containing Al by not less than 95 atomic %, it is possible to realize the optical disk which is cheap and which is excellent in corrosion resistance. Elements, which are to be added to Al and which are excellent in corrosion resistance, include, for example, Co, Ti, Cr, Ni, Mg, Si, V, Ca, Fe, Zn, Zr, Nb, Mo, Rh, Sn, Sb, Te, Ta, W, Ir, Pb, B, and C. However, when the element to be added is Co, Cr, Ti, Ni, and Fe, an effect is especially obtained to improve the corrosion resistance.

When the metal element, which is contained in the heat-diffusing layer, is the same as the metal element contained in the absorptance control layer, a great advantage is obtained in view of the production, for the following reason. That is, the two layers of the absorptance control layer and the heat-diffusing layer can be formed by using an identical target. Specifically, when the absorptance control layer is formed, then the sputtering is performed with a mixed gas such as Ar—O₂ mixed gas and Ar—N₂ mixed gas, and the metal element is reacted with oxygen or nitrogen during the sputtering. Thus, the absorptance control layer having an appropriate refractive index is formed. After that, when the heat-diffusing layer is formed, then the sputtering is performed with Ar gas, and the metal heat-diffusing layer having a high coefficient of thermal conductivity can be formed.

It is preferable that the thickness of the heat-diffusing layer is 30 nm to 300 nm. In particular, when the thickness of the heat-diffusing layer is 30 nm to 150 nm, the corrosion resistance and the productivity are further improved, which is more desirable. If the thickness of the heat-diffusing layer is thinner than 30 nm, the heat, which is generated in the recording layer, is hardly diffused. Therefore, especially when the rewriting is performed about hundred thousand times, then the recording layer not only tends to be deteriorated, but the cross-erase also tends to be caused in some cases. If the thickness of the heat-diffusing layer is thinner than 30 nm, it is difficult to make the use as the heat-diffusing layer, because the light is transmitted. In this situation, the reproduced signal amplitude is lowered in some cases. If the thickness of the heat-diffusing layer is thick, i.e., not less than 300 nm, then the productivity is not only deteriorated, but any warpage of the substrate is caused by the internal stress of the heat-diffusing layer. It is impossible to correctly record and reproduce the information in some cases.

As described above, according to the optical disk, the recording and reproducing apparatus, and the method for managing the address information of the present invention, even when the address information of the predetermined track cannot be reproduced, it is possible to specify the address information of the predetermined track more easily and highly reliably from the address information of the adjoining track. Therefore, the reliability of the address information is improved even when the track pitch is decreased in order to realize the large capacity. Further, the data information can be also recorded in the area in which the address information is recorded. Therefore, it is possible to enhance the format efficiency.

According to the optical disk of the present invention, the recording layer is formed of the phase-change material which contains Bi, Ge, and Te, or the phase-change material which contains Bi and which contains the compound based on at least one of the crystalline systems of the cubic system and the tetragonal system. Therefore, even when the deflection amount of the wobble of the header section for forming the address information is increased to some extent, it is possible to obtain the sufficient data signal quality. Further, even when the data information is repeatedly rewritten, it is possible to suppress the deterioration of the signal quality. Therefore, when the optical disk of the present invention is used, then the reliability of the address information is not only improved, but it is also possible to improve the repeated rewriting characteristic of the data information.

1. An optical disk comprising:
a substrate which is formed with a plurality of grooves; and
a recording layer which is provided on the substrate and which is formed of a phase-change material, containing Bi, Ge, and Te, wherein:
header sections are provided for the plurality of grooves respectively, address information of each of the grooves is recorded on one of the header sections of the grooves by deflecting the grooves in a radial direction, and the header sections of the plurality of grooves are arranged and aligned in the radial direction.

2. The optical disk according to claim 1, wherein a plurality of lands are defined between the plurality of grooves, header sections are provided for the plurality of lands respectively, address information of each of the lands is recorded on one of the header sections of the lands by deflecting the lands in a radial direction, and the header sections of the plurality of lands are arranged and aligned in the radial direction.

3. The optical disk according to claim 1, wherein the following relationship holds among a track pitch TP of the optical disk, a wavelength λ of a recording and reproducing light beam, and a numerical aperture NA of a light-collecting lens, and the wavelength λ is 390 nm to 420 nm:
0.35×(λ/NA)≦TP≦0.7×(λ/NA).

4. The optical disk according to claim 1, wherein a composition ratio of Bi, Ge, and Te contained in the recording layer is represented by ((GeTe)ₓ(Bi₂Te₃)₁₋ₓ)_{1-y}Ge_{y}, and 0.3≦x<1 and 0<y≦0.4 hold for x and y respectively.

5. The optical disk according to claim 4, further comprising a protective layer, an intermediate layer, and a heat-diffusing layer, wherein the protective layer, the recording layer, the intermediate layer, and the heat-diffusing layer are provided in this order from a side into which a recording and reproducing light beam comes, the protective layer has a thickness of 40 nm to 80 nm, the recording layer has a thickness of 5 nm to 25 nm, the intermediate layer has a thickness of 30 nm to 60 nm, and the heat-diffusing layer has a thickness of 30 nm to 300 nm.

6. The optical disk according to claim 5, wherein a material for forming the intermediate layer contains, by not less than 25%, a material which has a refractive index of not more than 1.7 at a wavelength λ of the recording and reproducing light beam and which has an extinction coefficient of not more than 0.1.

7. An optical disk comprising:
a substrate which is formed with a plurality of grooves; and
a recording layer which is provided on the substrate and which is formed of a phase-change material containing Bi of not more than 28 atomic %, wherein:
header sections are provided for the plurality of grooves respectively, address information of each of the grooves is recorded on one of the header sections of the grooves by deflecting the grooves in a radial direction, and the header sections of the plurality of grooves are arranged and aligned in the radial direction.

8. The optical disk according to claim 7, wherein a plurality of lands are defined between the plurality of grooves, header sections are provided for the plurality of lands respectively, address information of each of the lands is recorded on one of the header sections of the lands by deflecting the lands in a radial direction, and the header sections of the plurality of lands are arranged and aligned in the radial direction.

9. The optical disk according to claim 7, wherein the phase-change material contains Te.

10. The optical disk according to claim 7, wherein the phase-change material contains Ge and Te.

11. The optical disk according to claim 7, wherein the phase-change material has at least one of crystalline systems of a cubic system and a tetragonal system.

12. The optical disk according to claim 7, wherein the following relationship holds among a track pitch TP of the optical disk, a wavelength λ of a recording and reproducing light beam, and a numerical aperture NA of a light-collecting lens, and the wavelength λ is 390 nm to 420 nm:
0.35×(λ/NA)≦TP≦0.7×(λ/NA).

13. The optical disk according to claim 10, wherein a composition ratio of Bi, Ge, and Te contained in the recording layer is represented by and 0.3≦x<1 and 0<y≦0.4 hold for x and y respectively.

14. The optical disk according to claim 13, further comprising a protective layer, an intermediate layer, and a heat-diffusing layer, wherein the protective layer, the recording layer, the intermediate layer, and the heat-diffusing layer are provided in this order from a side into which a recording and reproducing light beam comes, the protective layer has a thickness of 40 nm to 80 nm, the recording layer has a thickness of 5 nm to 25 nm, the intermediate layer has a thickness of 30 nm to 60 nm, and the heat-diffusing layer has a thickness of 30 nm to 300 nm.

15. The optical disk according to claim 14, wherein a material for forming the intermediate layer contains, by not less than 25%, a material which has a refractive index of not more than 1.7 at a wavelength λ of the recording and reproducing light beam and which has an extinction coefficient of not more than 0.1.

16. An optical disk comprising:
a substrate which is formed with a plurality of grooves; and
a recording layer which is provided on the substrate and which is formed of a phase-change material containing Bi, Ge, and Te, wherein:
header sections are provided for the plurality of grooves respectively, address information of each of the grooves is recorded on one of the header sections of the grooves by deflecting the grooves in a radial direction, and a header section of a certain groove of the grooves and a header section of an adjoining groove to the certain groove are arranged and deviated from each other in a circumferential direction.

17. The optical disk according to claim 16, wherein the following relationship holds among a track pitch TP of the optical disk, a wavelength λ of a recording and reproducing light beam, and a numerical aperture NA of a light-collecting lens, and the wavelength λ is 390 nm to 420 nm:
0.35×(λ/NA)≦TP≦0.7×(λ/NA).

18. The optical disk according to claim 16, wherein a composition ratio of Di, Ge, and Te contained in the recording layer is represented by ((GeTe)ₓ(Bi₂Te₃)₁₋ₓ)_{1-y}Ge_{y}, and 0.3≦x<1 and 0<y≦0.4 hold for x and y respectively.

19. The optical disk according to claim 18, further comprising a protective layer, an intermediate layer, and a heat-diffusing layer, wherein the protective layer, the recording layer, the intermediate layer, and the heat-diffusing layer are provided in this order from a side into which a recording and reproducing light beam comes, the protective layer has a thickness of 40 nm to 80 nm, the recording layer has a thickness of 5 nm to 25 nm, the intermediate layer has a thickness of 30 nm to 60 nm, and the heat-diffusing layer has a thickness of 30 nm to 300 nm.

20. The optical disk according to claim 19, wherein a material for forming the intermediate layer contains, by not less than 25%, a material which has a refractive index of not more than 1.7 at a wavelength λ of the recording and reproducing light beam and which has an extinction coefficient of not more than 0.1.

21. An optical disk comprising:
a substrate which is formed with a plurality of grooves; and
a recording layer which is provided on the substrate and which is formed of a phase-change material containing Bi of not more than 28 atomic %, wherein:
header sections are provided for the plurality of grooves respectively, address information of each of the grooves is recorded on one of the header sections of the grooves by deflecting the grooves in a radial direction, and a header section of a certain groove of the grooves and a header section of an adjoining groove to the certain groove are arranged and deviated from each other in a circumferential direction.

22. The optical disk according to claim 21, wherein the phase-change material contains Te.

23. The optical disk according to claim 21, wherein the phase-change material contains Ge and Te.

24. The optical disk according to claim 21, wherein the phase-change material has at least one of crystalline systems of a cubic system and a tetragonal system.

25. The optical disk according to claim 21, wherein the following relationship holds among a track pitch TP of the optical disk, a wavelength λ of a recording and reproducing light beam, and a numerical aperture NA of a light-collecting lens, and the wavelength % is 390 nm to 420 nm:
0.35×(λ/NA)≦TP≦0.7×(λ/NA).

26. The optical disk according to claim 23, wherein a composition ratio of Bi, Ge, and Te contained in the recording layer is represented by ((GeTe)ₓ(Bi₂Te₃)₁₋ₓ)_{1-y}Ge_{y}, and 0.3≦x<1 and 0<y≦0.4 hold for x and y respectively.

27. The optical disk according to claim 26, further comprising a protective layer, an intermediate layer, and a heat-diffusing layer, wherein the protective layer, the recording layer, the intermediate layer, and the heat-diffusing layer are provided in this order from a side into which a recording and reproducing light bear comes, the protective layer has a thickness of 40 nm to 80 nm, the recording layer has a thickness of 5 nm to 25 nm, the intermediate layer has a thickness of 30 nm to 60 nm, and the heat-diffusing layer has a thickness of 30 nm to 300 nm.

28. The optical disk according to claim 27, wherein a material for forming the intermediate layer contains, by not less than 25%, a material which has a refractive index of not more than 1.7 at a wavelength λ of the recording and reproducing light beam and which has an extinction coefficient of not more than 0.1.

29. The optical disk according to claim 21, wherein information is recorded on the grooves and lands defined therebetween.

30. A recording and reproducing apparatus for an optical disk comprising a substrate which is formed with a plurality of grooves, and a recording layer which is provided on the substrate and which is formed of a phase-change material containing Bi, Ge, and Te, wherein header sections are provided for the plurality of grooves respectively, address information of each of the grooves is recorded on one of the header sections of the grooves by deflecting the grooves in a radial direction, and the header sections of the plurality of grooves are arranged and aligned in the radial direction, the recording and reproducing apparatus comprising:
a rotation control unit which rotates the optical disk;
an optical head which radiates a light beam onto the optical disk;
a reproduced signal-processing circuit which reproduces information on the basis of a reproduced signal detected by the optical head; and
an address information-managing unit which manages the address information reproduced by the reproduced signal-processing circuit, wherein:
the address information-managing unit reproduces address information of a predetermined groove of the grooves on the basis of address information of an adjoining groove to the predetermined groove when the address information, which is recorded on the predetermined groove of the optical disk, was failed to be reproduced.

31. The recording and reproducing apparatus according to claim 30, wherein a plurality of lands are defined between the plurality of grooves, header sections are provided for the plurality of lands respectively, address information of each of the lands is recorded on one of the header sections of the lands by deflecting the lands in a radial direction, and the header sections of the plurality of lands are arranged and aligned in the radial direction.

32. A recording and reproducing apparatus for an optical disk comprising a substrate which is formed with a plurality of grooves, and a recording layer which is provided on the substrate and which is formed of a phase-change material containing Bi, Ge, and Te, wherein header sections are provided for the plurality of grooves respectively, address information of each of the grooves is recorded on one of the header sections of the grooves by deflecting the grooves in a radial direction, and a header section of a certain groove of the grooves and a header section of an adjoining groove to the certain groove are arranged and deviated from each other in a circumferential direction, the recording and reproducing apparatus comprising:
a rotation control unit which rotates the optical disk;
an optical head which radiates a light beam onto the optical disk;
a reproduced signal-processing circuit which reproduces information on the basis of a reproduced signal detected by the optical head; and
an address information-managing unit which manages the address information reproduced by the reproduced signal-processing circuit, wherein:
the address information-managing unit reproduces address information of a predetermined groove of the grooves on the basis of address information of an adjoining groove to the predetermined groove when the address information, which is recorded on the predetermined groove of the optical disk, was failed to be reproduced.

33. A method for managing address information for an optical disk comprising a substrate which is formed with a plurality of grooves, and a recording layer which is provided on the substrate and which is formed of a phase change material containing Bi, Ge, and Te, wherein header sections are provided for the plurality of grooves respectively, address information of each of the grooves is recorded on one of the header sections of the grooves by deflecting the grooves in a radial direction, and the header sections of the plurality of grooves are arranged and aligned in the radial direction, wherein:
address information of a predetermined groove of the grooves is reproduced on the basis of address information of an adjoining groove to the predetermined groove when the address information, which is recorded on the predetermined groove of the optical disk, was failed to be reproduced.

34. The method for managing the address information according to claim 33, wherein a plurality of lands are defined between the plurality of grooves, header sections are provided for the plurality of lands respectively, address information of each of the lands is recorded on one of the header sections of the lands by deflecting the lands in a radial direction, and the header sections of the plurality of lands are arranged and aligned in the radial direction.

35. A method for managing address information for an optical disk comprising a substrate which is formed with a plurality of grooves, and a recording layer which is provided on the substrate and which is formed of a phase-change material containing Bi, Ge, and Te, wherein header sections are provided for the plurality of grooves respectively, address information of each of the grooves is recorded on one of the header sections of the grooves by deflecting the grooves in a radial direction, and a header section of a certain groove of the grooves and a header section of an adjoining groove to the certain groove are arranged and deviated from each other in a circumferential direction, wherein:
address information of a predetermined groove of the grooves is reproduced on the basis of address information of an adjoining groove to the predetermined groove when the address information, which is recorded on the predetermined groove of the optical disk, was failed to be reproduced.
